(19) United States
(12) Patent Application Publication
(10) Pub. No.: US 2026/0125272 A1
(43) Pub. Date: May 7, 2026

(54) ZEOLITIC MATERIALS AND METHODS OF MAKING AND USING THEREOF

(71) Applicant: Ohio State Innovation Foundation, Columbus, OH (US)

(72) Inventors: Leah FORD, Columbus, OH (US); Alexander SPANOS, Columbus, OH (US); Ambarish KULKARNI, Sacramento, CA (US); Nicholas BRUNELLI, Columbus, OH (US)

(21) Appl. No.: 19/118,894

(22) PCT Filed: Oct. 9, 2023
(86) PCT No.: PCT/US2023/034747

§ 371 Date: Apr. 7, 2025

Related U.S. Application Data
(60) Provisional application No. 63/414,445, filed on Oct. 7, 2022.

(51) Int. Cl. C01B 39/48

(52) U.S. Cl. CPC C01B 39/48; C01P 2002/74; C01P 2002/82; C01P 2002/86

(57) ABSTRACT

Described herein are methods for preparing a zeolitic material including a microporous crystalline framework isomorphously substituted with one or more paired Lewis acid sites.

### CROSS-REFERENCE TO RELATED APPLICATION

This application claims the benefit of U.S. Provisional Application 63/414,445, filed on Oct. 7, 2022, the contents of which is hereby incorporated in its entirety.

### STATEMENT REGARDING FEDERALLY SPONSORED RESEARCH OR DEVELOPMENT

This invention was made with Government Support under Grant No. 1653587 awarded by the National Science Foundation. The Government has certain rights in the invention.

### BACKGROUND

Zeolites are widely used as solid acid catalysts for conversion of biomass and petroleum-based feedstocks to chemicals and fuels. While the predominant use of zeolites remains for Brønsted acid catalyzed reactions, the catalytic capabilities of zeolites have greatly expanded with the introduction of Lewis acidic zeolites, such as TS-1, CIT-6, Sn-BEA, and other Lewis acidic zeolites. These powerful Lewis acidic zeolites can catalyze a whole new landscape of intriguing chemical reactions such as Meerwein-Poondorf-Verley reductions (MPV), aldol condensations, and the isomerization of glucose to fructose. Existing Lewis acidic zeolites include isolated metal centers, such as Ti, Zn, Hf, Zr, and Sn. Intriguingly, enzymes that catalyze similar reactions often include pairs of metal centers as opposed to isolated metal centers. In these enzymes, the catalytic pairs of metal centers are thought to increase both selectivity and activity. However, paired metal centers are challenging to achieve in heterogeneous catalytic materials.

Translating these beneficial features of enzymes to heterogeneous catalytic materials has been a longstanding challenge for the field of catalysis. Creating catalysts that include paired sites has been a challenge because heterogeneous catalytic materials typically possess catalytic sites that are non-uniform and/or randomly distributed. Yet, enzymes and homogeneous catalysis clearly demonstrate a benefit to creating catalytic material with paired sites. Numerous examples from homogeneous catalyst demonstrate that catalytic pairs can influence activity and selectivity. The key challenge remains how to achieve these catalytic pairs in heterogeneous catalytic materials such as zeolites. Zeolites are attractive targets since they are crystalline, can be shape selective, and can be made hydrophobic to enable Lewis acid chemistry in water. However, zeolites are highly challenging because these materials are synthesized using crystallization procedures that are only beginning to be understood beyond a phenomenological level.

There is a need for controlling the nature of the catalytic site and the environment around the catalytic active site to create highly active and selective catalytic materials.

The compositions and methods disclosed herein address these and other needs.

### SUMMARY

This application generally related to methods for creating catalytic materials (e.g., zeolitic materials) containing one or more paired Lewis acid sites. These methods can be used to create well-defined Lewis Acid site pairs in a zeolite framework.

The overall strategy can involve using an organometallic agent (e.g., an alkyl tin compound, an aryl tin compound, an alkylaryl tin compound, an alkyl Ge compound, an aryl Ce compound, an alkylaryl Ge compound, etc.) to create an open-defect Lewis acid (ODLA) site. The defect is a location that is the target for post-synthetic insertion of a second heteroatom.

In some examples, the first Lewis acid could be either alkyl-Sn or alkyl-Ge. In some embodiments, the second Lewis acid could either be: Sn, Zr, Hf, Ti, Nb.

Many different pairs could be of interest, but some specific examples of interest would be: (1) Ti—Ge; (2) Sn—Sn; (3) Zr—Sn; (4) Ti—Sn. Titanium paired with different Lewis acids have been demonstrated to have increased catalytic activity for the epoxidation of olefins. Sn—Sn and Sn—Zr pairs have the potential for cooperative activation of substrates for the aldol reaction.

Each of the one or more paired Lewis acid sites within the zeolitic material can comprise a first Lewis acid metal center and a second Lewis acid metal center. The first Lewis acid metal center and the second Lewis acid metal center can be separated by three or fewer atoms within the crystalline framework. For example, the first Lewis acid metal center and the second Lewis acid metal center can be separated by three atoms within the crystalline framework, or separated by one atom within the crystalline framework.

The first Lewis acid metal center and the second Lewis acid metal center can be separated by less than 10 Angstroms (e.g., less than 5 Angstroms, or less than 4 Angstroms), measured metal center to metal center. In certain embodiments, the first Lewis acid metal center and the second Lewis acid metal center are separated by from 2 to 4 Angstroms. In one embodiment, the first Lewis acid metal center and the second Lewis acid metal center are separated by from 2.5 to 3 Angstroms.

In some embodiments, each of the one or more paired Lewis acid sites in the zeolitic material can be defined by the formula below

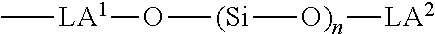

wherein LA¹ represents the first Lewis acid metal center; LA² represents the second Lewis acid metal center; and n is 0 or 1.

In some embodiments, n is 0, and each of the one or more paired Lewis acid sites in the zeolitic material can be defined by the formula below

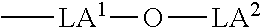

wherein LA¹ represents the first Lewis acid metal center; and LA² represents the second Lewis acid metal center. In other embodiments, n is 1, and each of the one or more paired Lewis acid sites in the zeolitic material can be defined by the formula below

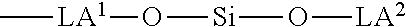

wherein LA1 represents the first Lewis acid metal center and LA2 represents the second Lewis acid metal center.

In some embodiments, the first Lewis acid metal center and the second Lewis acid metal center can independently chosen from Sn, Hf, Zn, Zr, Ti, V, Ta, Ga, Ge, Nb, and Cr. In some embodiments, the first Lewis acid metal center and the second Lewis acid metal center can independently chosen from Sn, Hf Zr, and Ge.

In some embodiments, at least one of the first Lewis acid metal center and the second Lewis acid metal center can be Ti.

In some embodiments, first Lewis acid metal center and the second Lewis acid metal center can be Ti—Ge, Sn—Sn, Zr—Sn, or Ti—Sn.

The first Lewis acid metal center and the second Lewis acid metal center can comprise the same metal or different metals. In some embodiments, the paired Lewis acid site can comprise a homodimner. In these instances, both the first Lewis acid metal center and the second Lewis acid metal center can comprise the same metal.

In other embodiments, paired Lewis acid site can comprise a heterodimer. In these instances, the first Lewis acid metal center and the second Lewis acid metal center can comprise different metals.

The quantity (and by extension concentration) of paired Lewis acid sites included within the microporous crystalline framework of the zeolitic material can be varied. For example, in some embodiments, the molar ratio of paired Lewis acid sites to Si atoms in the zeolitic material can be at least 1:1000 (e.g., at least 1:500, at least 1:400, or at least 1:200). In some embodiments, the molar ratio of paired Lewis acid sites to Si atoms in the zeolitic material can be from 1:1000 to 1:50 (e.g., from 1:400 to 1:50).

The zeolitic material can comprise suitable type of zeolite. For example, the zeolitic material can be of any suitable zeolite structural group (e.g., any suitable Nickel-Strunz classification). In some embodiments, the microporous crystalline framework can comprise BEA. In other embodiments, the microporous crystalline framework can comprise MFL.

### DESCRIPTION OF DRAWINGS

FIG. 1 shows XRD patterns of Ph-Sn-Beta, Bu-Sn-Beta, and Me-Sn-Beta.

FIG. 2 shows XRD patterns of Ph-Sn-Beta, Sn-Beta, Bu-Sn-Beta and Me-Sn-Beta with references for BEA and BEB frameworks from 2 theta of 5° to 10°.

FIG. 3 shows DRIFTS Spectra of ACN saturated onto, Ph-Sn-Beta, Bu-Sn-Beta, Me-Sn-Beta, Me-Sn-Beta-2, and conventional Sn-Beta normalized by the peak closed peak at 2308 cm⁻¹. Dashed lines indicate peak locations for open sites (2316 cm⁻¹) and closed sites (2308 cm⁻¹).

FIG. 4 shows a graph of ³¹P MAS NMR Spectra of 0.50 TMPO:total Sn for TMPO on Ph-Sn-Beta, Bu-Sn-Beta, Me-Sn-Beta, Me-Sn-Beta-2 and Sn-Beta Dashed lines are to guide the eyes.

FIG. 5 shows a graph of catalytic testing of Ph-Sn-Beta, Bu-Sn-Beta and Me-Sn-Beta for epoxide ring opening of 0.4M epichlorohydrin in methanol at 60° C. with a molar epoxide:Sn of 250:1.

FIG. 6 shows a graph of catalytic testing of Ph-Sn-Beta, Bu-Sn-Beta and Me-Sn-Beta for epoxide ring opening of 0.4M 1,2-epoxyhexane (EH) in methanol (MeOH) at 60° C. with a molar epoxide:Sn of 250:1.

FIG. 7 shows a graph of the comparison of the reaction rate constant for zeolite Beta materials made using different alkyl tin compounds, including Me-Sn-Beta, n-Bu-Sn-Beta, or Ph-Sn-Beta. The reaction rates are reported for epichlorohydrin ring opening with methanol (left/red axis) and 1,2-epoxyhexane ring opening with methanol (right axis).

FIG. 8 shows a graph of the percent of integrated area from ³¹P MAS NMR for peaks appearing lower than 54.5 ppm divided by total peak area for each material vs. the materials calculated rate constant for epoxide ring opening of 0.4 M epichlorohydrin in methanol at 60° C.

FIG. 9 shows a graph of deconvoluted peak areas of open sites/closed site from saturated d3-ACN on DRIFTS vs. the materials calculated rate constant for epoxide ring opening of 0.4M epichlorohydrin in methanol at 60° C.

FIG. 10 shows a scheme of post synthesis fluoride treatment.

FIG. 11 is a graph showing increased hydrophobicity.

FIG. 12 shows XRD patterns of Sn-Beta, nano-Sn-Beta-TEAF, and nano-Sn-Beta.

FIG. 13 shows a graph of N2 Physisorption of Sn-Beta, nano-Sn-Beta-TEAF, and nano-Sn-Beta.

FIG. 14 shows a graph of water adsorption of Sn-Beta, nano-Sn-Beta-TEAF, and nano-Sn-Beta.

FIG. 15 shows a graph of 29Si MAS NMR of Sn-Beta, nano-Sn-Beta-TEAF, and nano-Sn-Beta.

FIG. 16 is a graph showing the effect of hydrophobicity on epoxide ring opening.

FIG. 17 shows a graph of 19F MAS NMR of Sn-Beta, nano-Sn-Beta-TEAF, nano-Sn-Beta, nano-Sn-Beta-TEAF-assynth, and nano-Sn-Beta-TEAF-NMe₄OH.

FIG. 18 is a graph showing the effect of residual fluorine on the activity.

FIG. 19 is a graph showing site quantification with Lewis base poison.

FIG. 20 is a graph showing activity per site.

FIG. 21 is a graph comparing XRD spectra for de-Al-Beta-OH, de-Al-Beta-F, Ti-Beta-F, Me-Si-Beta, and Si-Beta.

FIG. 22 is a graph of nitrogen physisorption of de-Al-Beta-OH, de-Al-Beta-F, Ti-Beta-F, Me-Si-Beta-0.04, and Si-Beta. The isotherms have been offset by 100.

FIG. 23 is a graph comparing the water adsorption isotherms of de-Al-Beta-OH, de-Al-Beta-F, Ti-Beta-F, Me-Si-Beta-0.04, and Si-Beta.

FIG. 24 is a graph comparing the quantity of water adsorbed in de-Al-Beta-OH, de-Al-Beta-F, Ti-Beta-F, Me-Si-Beta-0.04, and Si-Beta at a P/P₀=0.9.

FIG. 25 shows a comparison of the FTIR spectra of de-Al-Beta-OH, de-Al-Beta-F, Ti-Beta-F, Me-Si-Beta-0.04, and Si-Beta.

FIG. 26 shows a comparison of the FTIR spectra de-Al-Beta-OH, de-Al-Beta-F, Ti-Beta-F, Me-Si-Beta-0.04, and Si-Beta.

FIG. 27 shows a comparison of the FTIR spectra de-Al-Beta-OH, de-Al-Beta-F, Ti-Beta-F, Me-Si-Beta-0.04, and Si-Beta.

FIG. 28 shows a comparison of 29Si NMR of Si-Beta, Me-Si-Beta-0.04, de-Al-Beta-F-0.04, and de-Al-Beta-OH-0.04.

FIG. 29 shows a comparison of DRUVS of Ti species.

FIG. 30 shows a comparison of DRIFTS of acetonitrile bound to active sites.

FIG. 31 shows a comparison of DRIFTS of acetonitrile bound to active sites.

FIG. 32 shows a comparison of DRIFTS of acetonitrile bound to active sites.

FIG. 33 shows ³¹P MAS NMR TMPO dosed onto Ti sites.

FIG. 34 shows a comparison of the concentration of different species over time for the MPV reduction of furfural with isopropanol with de-Al-Beta-OH.

FIG. 35 shows a comparison of the concentration of different species over time for the MPV reduction of furfural with isopropanol with PS-Ti (de-Al)-Beta-F using 3 mol % of catalyst.

FIG. 36 shows a comparison of the concentration of different species over time for the MPV reduction of furfural with isopropanol with Ti-Beta-F using 3 mol % of catalyst.

FIG. 37 shows a comparison of the concentration of different species over time for the MPV reduction of furfural with isopropanol with PS-Ti Me-Si-Beta-0.04 using 3 mol % of catalyst.

FIG. 38 shows a comparison of the concentration of different species over time for the MPV reduction of furfural with isopropanol with PS-Ti Si-Beta using 3 mol % of catalyst.

FIG. 39 shows a comparison of the concentration of different species over time for the MPV reduction of furfural with isopropanol with PS-Ti Me-Si-Beta-0.04 using 12 mol % of catalyst.

FIG. 40 shows a comparison of the conversion over time for the alkene in the epoxidation with hydrogen peroxide.

FIG. 41 shows a comparison of the selectivity for the formation of 1,2-epoxyoctane with different catalysts.

FIG. 42 shows epoxidation H₂O₂ Decomposition.

FIG. 43 shows a graph of catalytic activity showing that waiting 7 days to calcine (AS—days since the material was “as synthesized”) a material and 14 additional days after calcination (PC—post calcination), a material that has increased catalytic activity.

Like reference symbols in the various drawings indicate like elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

The prefix Cₙ-Cₘ preceding a group or moiety indicates, in each case, the possible number of carbon atoms in the group or moiety that follows.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, heteroatoms present in a compound or moiety, such as nitrogen, can have hydrogen substituents and/or any permissible substituents of organic compounds described herein which satisfy the valency of the heteroatom. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound (e.g., a compound that does not spontaneously undergo transformation such as by rearrangement, cyclization, elimination, etc.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may be unsubstituted or substituted with one or more chemical moieties. The alkyl group can be substituted with one or more groups including, but not limited to, hydroxy, halogen, acyl, alkyl, alkoxy, alkenyl, alkynyl, aryl, heteroaryl, acyl, aldehyde, amino, carboxylic acid, ester, ether, ketone, nitro, silyl, sulfo-oxo, sulfonyl, sulfone, sulfoxide, thiosulfonate (e.g., —SSO₂Ra), or thiol, as described below, provided that the substituents are sterically compatible and the rules of chemical bonding and strain energy are satisfied. The alkyl group can also include one or more heteroatoms (e.g., from one to three heteroatoms) incorporated within the hydrocarbon moiety. Examples of heteroatoms include, but are not limited to, nitrogen, oxygen, sulfur, and phosphorus.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. The term “alkylthiol” specifically refers to an alkyl group that is substituted with one or more thiol groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₁-C₁₆, C₂-C₁₄, C₂-C₁₂, C₂-C₁₀, C₂-C₈, C₁-C₆, C₁-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure—CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, thiosulfonate (e.g., —SSO₂Ra), or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, I-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, thiosulfonate (e.g., —SSO₂Ra), or thiol, as described below.

As used herein, the term “aryl,” as well as derivative terms such as aryloxy, refers to groups that include a monovalent aromatic carbocyclic group of from 3 to 20 carbon atoms. Aryl groups can include a single ring or multiple condensed rings. In some embodiments, aryl groups include C₆-C₁₀ aryl groups. Examples of aryl groups include, but are not limited to, phenyl, biphenyl, naphthyl, tetrahydronaphthyl, phenylcyclopropyl, and indanyl. In some embodiments, the aryl group can be a phenyl, indanyl or naphthyl group. The term “heteroaryl” is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is included in the term “aryl,” defines a group that contains an aromatic group that does not contain a heteroatom. The aryl or heteroaryl substituents may be unsubstituted or substituted with one or more chemical moieties. Examples of suitable substituents include, for example, alkyl, halogenated alkyl, alkoxy, alkenyl, alkynyl, aryl, heteroaryl, acyl, aldehyde, amino, carboxylic acid, cycloalkyl, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

As used herein, “heteroaryl” refers to a monocyclic or polycyclic aromatic heterocycle having at least one heteroatom ring member selected from sulfur, oxygen, and nitrogen. In some embodiments, the heteroaryl ring has 1, 2, 3, or 4 heteroatom ring members independently selected from nitrogen, sulfur and oxygen. In some embodiments, any ring-forming N in a heteroaryl moiety can be an N-oxide. In some embodiments, the heteroaryl has 5-10 ring atoms and 1, 2, 3 or 4 heteroatom ring members independently selected from nitrogen, sulfur and oxygen. In some embodiments, the heteroaryl has 5-6 ring atoms and 1 or 2 heteroatom ring members independently selected from nitrogen, sulfur and oxygen. In some embodiments, the heteroaryl is a five-membered or six-membered heteroaryl ring. A five-membered heteroaryl ring is a heteroaryl with a ring having five ring atoms wherein one or more (e.g., 1, 2, or 3) ring atoms are independently selected from N, O, and S. Exemplary five-membered ring heteroaryls are thienyl, furyl, pyrrolyl, imidazolyl, thiazolyl, oxazolyl, pyrazolyl, isothiazolyl, isoxazolyl, 1,2,3-triazolyl, tetrazolyl, 1,2,3-thiadiazolyl, 1,2,3-oxadiazolyl, 1,2,4-triazolyl, 1,2,4-thiadiazolyl, 1,2,4-oxadiazolyl, 1,3,4-triazolyl, 1,3,4-thiadiazolyl, and 1,3,4-oxadiazolyl. A six-membered heteroaryl ring is a heteroaryl with a ring having six ring atoms wherein one or more (e.g., 1, 2, or 3) ring atoms are independently selected from N, O, and S. Exemplary six-membered ring heteroaryls are pyridyl, pyrazinyl, pyrimidinyl, triazinyl and pyridazinyl.

As used herein, “heterocycloalkyl” refers to non-aromatic monocyclic or polycyclic heterocycles having one or more ring-forming heteroatoms selected from O, N, or S. Included in heterocycloalkyl are monocyclic 4-, 5-, 6-, and 7-membered heterocycloalkyl groups. Heterocycloalkyl groups can also include spirocycles. Example heterocycloalkyl groups include pyrrolidin-2-one, 1,3-isoxazolidin-2-one, pyranyl, tetrahydropuran, oxetanyl, azetidinyl, morpholino, thiomorpholino, piperazinyl, tetrahydrofuranyl, tetrahydrothienyl, piperidinyl, pyrrolidinyl, isoxazolidinyl, isothiazolidinyl, pyrazolidinyl, oxazolidinyl, thiazolidinyl, imidazolidinyl, azepanyl, benzazapene, and the like. Ring-forming carbon atoms and heteroatoms of a heterocycloalkyl group can be optionally substituted by oxo or sulfido (e.g., C(O), S(O), C(S), or S(O)₂, etc.). The heterocycloalkyl group can be attached through a ring-forming carbon atom or a ring-forming heteroatom. In some embodiments, the heterocycloalkyl group contains 0 to 3 double bonds. In some embodiments, the heterocycloalkyl group contains 0 to 2 double bonds. Also included in the definition of heterocycloalkyl are moieties that have one or more aromatic rings fused (i.e., having a bond in common with) to the cycloalkyl ring, for example, benzo or thienyl derivatives of piperidine, morpholine, azepine, etc. A heterocycloalkyl group containing a fused aromatic ring can be attached through any ring-forming atom including a ring-forming atom of the fused aromatic ring. In some embodiments, the heterocycloalkyl has 4-10, 4-7 or 4-6 ring atoms with 1 or 2 heteroatoms independently selected from nitrogen, oxygen, or sulfur and having one or more oxidized ring members.

At certain places, the definitions or embodiments refer to specific rings (e.g., an azetidine ring, a pyridine ring, etc.). Unless otherwise indicated, these rings can be attached to any ring member provided that the valency of the atom is not exceeded. For example, an azetidine ring may be attached at any position of the ring, whereas a pyridin-3-yl ring is attached at the 3-position.

The term “acyl” as used herein is represented by the formula —C(O)Z¹ where Z¹ can be a hydrogen, hydroxyl, alkoxy, alkyl, halogenated alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a short hand notation for C═O.

As used herein, the term “alkoxy” refers to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H.

The terms “amine” or “amino” as used herein are represented by the formula —NZ¹Z², where Z¹ and Z² can each be substitution group as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NZ¹Z².

The term “carboxylic acid” as used herein is represented by the formula —C(O)OH. A “carboxylate” or “carboxyl” group as used herein is represented by the formula —C(O)O′.

The term “ester” as used herein is represented by the formula —OC(O)Z¹ or —C(O)OZ¹, where Z¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula Z¹C(O)Z², where Z¹ and Z can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiZ¹Z²Z³, where Z¹, Z², and Z³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

The term “sulfonyl” is used herein to refer to the sulfo-oxo group represented by the formula —S(O)₂Z¹, where Z¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfonylamino” or “sulfonamide” as used herein is represented by the formula —S(O)₂NH—.

The term “thiol” as used herein is represented by the formula —SH.

The term “thio” as used herein is represented by the formula —S—.

As used herein, Me refers to a methyl group; OMe refers to a methoxy group; and i-Pr refers to an isopropyl group.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

The term “substituted” refers to a molecule wherein at least one hydrogen atom is replaced with a substituent. When substituted, one or more of the groups are “substituents.” The molecule can be multiply substituted. In the case of an oxo substituent (“=O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Methods of Making

Described herein are methods for preparing a zeolitic material including a microporous crystalline framework isomorphously substituted with one or more paired Lewis acid sites. In some embodiments, each of the one or more paired Lewis acid sites includes a first Lewis acid metal center and a second Lewis acid metal center. In some embodiments, the first Lewis acid metal center and the second Lewis acid metal center are separated by three or fewer atoms within the crystalline framework. In some embodiments, the method including: (i) combining, in aqueous solution, a silicon source, a Lewis acid metal precursor, and optionally a structure-directing agent to form a precursor gel; (ii) reacting the precursor gel under conditions effective to form a protected zeolitic material; (iii) treating the protected zeolitic material to form the zeolitic material including the microporous crystalline framework isomorphously substituted with one or more paired Lewis acid-open defect sites, each including a first Lewis acid metal center and an open defect site; and (iv) post-synthetically incorporating a metal at the open defect sites to form one or more paired Lewis acid sites includes a first Lewis acid metal center and a second Lewis acid metal center.

Described herein are methods for preparing a zeolitic material including a microporous crystalline framework isomorphously substituted with one or more paired Lewis acid sites, wherein each of the one or more paired Lewis acid sites includes a first Lewis acid metal center and a second Lewis acid metal center, and wherein the first Lewis acid metal center and the second Lewis acid metal center are separated by three or fewer atoms within the crystalline framework; the method including: (i) combining, in aqueous solution, a silicon source, a Lewis acid metal precursor, and optionally a structure-directing agent to form a precursor gel; (ii) reacting the precursor gel under conditions effective to form a protected zeolitic material; (iii) treating the protected zeolitic material to form the zeolitic material including the microporous crystalline framework isomorphously substituted with one or more paired Lewis acid-open defect sites, each including a first Lewis acid metal center and an open defect site; and (iv) post-synthetically incorporating a metal at the open defect sites to form one or more paired Lewis acid sites includes a first Lewis acid metal center and a second Lewis acid metal center.

As used herein, the terms “isomorphously substituted” and “isomorphous substitution” refer to the substitution of one element for another in a mineral without a significant change in the crystal structure. Elements that can substitute for each other generally have similar ionic radii and valence state. In one or more embodiments, a fraction of the silicon atoms are isomorphously substituted with a tetravalent metal. In other words, a fraction of the silicon atoms in the zeolitic framework material are being replaced with a tetravalent metal. Such isomorphous substitution does not significantly alter the crystal structure of the zeolitic framework material.

In some embodiments, step (i) includes combining, in aqueous solution, the silicon source, the Lewis acid metal precursor, and the structure-directing agent to form a precursor gel.

In some embodiments, step (ii) includes incubating the precursor gel to hydrolyze the silicon source. In some embodiments, step (ii) includes heating the precursor gel in the presence of zeolite seed crystals, a fluoride source, or a combination thereof to form the protected zeolitic material. In some embodiments, step (ii) includes heating the precursor gel in the presence of zeolite seed crystals to form the protected zeolitic material. In some embodiments, step (ii) includes heating the precursor gel in the presence of a fluoride source to form the protected zeolitic material. In some embodiments, step (ii) includes heating the precursor gel in the presence of zeolite seed crystals and a fluoride source to form the protected zeolitic material.

In some embodiments, step (iii) includes calcining the protected zeolitic material to form the zeolitic material including the microporous crystalline framework isomorphously substituted with one or more paired Lewis acid-open defect sites. In some embodiments, calcining can be performed immediately after step (ii). In some embodiments, calcining can be performed at least 5 minutes after step (ii), (e.g., at least 10 minutes, at least 15 minutes, at least 30 minutes, at least 1 hour, at least 2 hours, at least 4 hours at least 6 hours, at least 12 hours, at least 1 day, at least 2 days, at least 3 days, at least 4 days, at least 5 days, at least 6 days, at least 7 days, at least 8 days, or at least 9 days).

In some embodiments, calcining can be performed 10 days or less after step (ii) (e.g., 9 days or less, 8 days or less, 7 days or less, 6 days or less, 5 days or less, 4 days or less, 3 days or less, 2 days or less, 1 day or less, 30 minutes or less, 15 minutes or less, 10 minutes or less).

Calcining can be performed from any of the minimum values described above to any of the maximum values described above. For example, in some embodiments, calcining can be performed from 5 minutes after step (ii) to 10 days after step (ii) (e.g., from 5 minutes to 9 days, from 5 minutes to 8 days, from 5 minutes to 7 days, from 5 minutes to 6 days, from 5 minutes to 5 days, from 5 minutes to 4 days, from 5 minutes to 3 days, from 5 minutes to 2 days, from 5 minutes to 1 day, from 5 minutes to 12 hours, from 5 minutes to 6 hours, from 5 minutes to 4 hours, from 5 minutes to 2 hours, from 5 minutes to 1 hour, from 5 minutes to 45 minutes, from 5 minutes to 30 minutes, from 5 minutes to 15 minutes, or from 5 minutes to 10 minutes. In some preferred embodiments, calcining can be performed at least 7 days after step (ii).

In some embodiments, step (iii) includes heating the protected zeolitic material in air at a temperature of from 400° C. to 750° C. In some embodiments, step (iii) includes extracting the protected zeolitic material to form the zeolitic material including the microporous crystalline framework isomorphously substituted with one or more paired Lewis acid-open defect sites.

In some embodiments, the Lewis acid metal precursor is defined by Formula II:

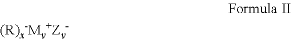

wherein
R is alkyl, cycloalkyl, aryl, or any combination thereof,
M is a transition metal, post transition metal, or any combination thereof,
Z is a halogen, acetate, sulfate, nitrate phosphate, carbonate, or bicarbonate,
x is an integer from 1-3, and
y is an integer from 1-3,
wherein the total charge of the compound of Formula II is a neutral charge.

In some embodiments, M includes a transition metal. In some embodiments, the transition metal can include scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold, actinium, rutherfordium, dubnium, seaborgium, bohrium, hassium, meitnerium, darmstadtium, roentgenium, or copernicium. In some embodiments, M is palladium. In some embodiments, M is platinum. In some embodiments, M is radium.

In some embodiments, M includes a post-transition metal. In some embodiments, M is chosen from Sn, Hf, Zn, Zr, Ti, V, Ta, Ga, Ge, Nb, and Cr.

In some embodiments, a method, wherein the M is Sn. In some embodiments, M is Hf. In some embodiments, M is Zn. In some embodiments, M is Zr. In some embodiments, M is Ti. In some embodiments, M is V. In some embodiments, M is Ta. In some embodiments, M is Ga. In some embodiments, M is Ge. In some embodiments, M is Nb. In some embodiments, M is Cr. Preferably, in some embodiments, M is chosen from Sn, Ti, and Ge.

In some embodiments, R includes C₁-C₁₀ alkyl, C₃-C₁₀ cycloalkyl, C₃-C₁₀ aryl, or any combination thereof. In some embodiments, R includes a C₁-C₁₀ alkyl. In some embodiments, R includes a C₃-C₁₀ aryl. In some embodiments, R includes a C₁-C₁₀ cycloalkyl.

In some embodiments, Z is acetate. In some embodiments, Z is sulfate. In some embodiments, Z is nitrate phosphate. In some embodiments, Z is carbonate. In some embodiments, Z is bicarbonate. In some embodiments, Z includes a halogen (e.g., F, Cl, Br, or I). In some embodiments, Z is Cl. In some embodiments, Z is Br. In some embodiments, Z is F. In some embodiments, Z is I.

In some embodiments, x is 1 to 2. In some embodiments, x is 2 to 3. In some embodiments, x is 1. In some embodiments, x is 2. In some embodiments, x is 3.

In some embodiments, y is 1 to 2. In some embodiments, y is 2 to 3. In some embodiments, y is 1. In some embodiments, y is 2. In some embodiments, y is 3.

In some embodiments, x is 1 and y is 3. In some embodiments, x is 1 and y is 1. In some embodiments, x is 1 and y is 2. In some embodiments, x is 2 and y is 1. In some embodiments, x is 2 and y is 2. In some embodiments, x is 2 and y is 3. In some embodiments, x is 3 and y is 1. In some embodiments, x is 3 and y is 2. In some embodiments, x is 3 and y is 3.

In some embodiments, the Lewis acid metal precursor is methyl-Sn—Cl₃. In some embodiments, the Lewis acid metal precursor is n-butyl-Sn—Cl₃. In some embodiments, the Lewis acid metal precursor is phenyl-Sn—Cl₃.

In some embodiments, described herein are also zeolitic materials prepared by the method described herein. In some embodiments, the zeolitic materials prepared can have improved catalytic activity after at least 10 days of calcination (e.g., at least 11 days, at least 12 days, at least 13 days, at least 14 days, at least 15 days, at least 16 days, at least 17 days, at least 18 day, or at least 19 days). In some preferred embodiments, the zeolitic materials prepared can have improved catalytic activity after at least 14 days of calcination.

The details of one or more embodiments of the disclosure are set forth in the accompanying drawings and the description below. Other features, objects, and advantages of the disclosure will be apparent from the description and drawings, and from the claims.

By way of non-limiting illustration, examples of certain embodiments of the present disclosure are given below.

### EXAMPLES

### Example 1: Tuning the Nature of the Catalytic Site Through Synthesizing Lewis Acid Zeolite Beta with Alkyl-Sn Precursors

### Introduction

Zeolites are important heterogeneous catalytic materials that can be used in a substantial range of chemical reactions. Advances in synthesis have open the possibility for new catalytic chemistry, including creating the opportunity to produce Lewis acid zeolites such as Sn-Beta. Sn-Beta is known to have different types of sites that have a range of catalytic activities, which can be difficult to elucidate. The key challenge is identifying synthetic methods that produce uniform catalytic sites. The current synthesis methods to produce Sn-Beta produce an active catalyst with limited control over the nature of the catalytic site. Beyond Lewis acid zeolites, the methods to control the structure around the active site has predominantly been through using different structure directing agents (SDAs). The different SDAs tend to produce different frameworks rather than altering just the structure around the active site. Controlling the nature of the catalytic site and the environment around the active site has the potential to unlock a new domain for material design to create highly active and selective catalytic materials.

Typically, Sn-Beta is synthesized hydrothermally through combining a tin source with an organic structure directing agent and a silica source. The tin can be incorporated into the material in different locations with different structures. Specifically, the tin can be incorporated as extra-framework tin oxide clusters or in the framework as isolated catalytic sites. Whereas hydroxide mediated routes can produce materials with nearly all of the catalytic sites being in the framework,¹ typical fluoride mediated syntheses tend to produce approximately 30% of the tin being inactive (likely tin oxide) and 70% of the tin being active. The active sites can be either (1) closed,^{2,3} (2) open-hydrolyzed, or (3) open-defect.³ Closed sites would consist of a single tin atom that is bonded to four adjacent silicon atoms through an oxygen whereas open-hydrolyzed sites would involve three bonds to adjacent silicon with a hydrolyzed bond that results in a hydroxyl group. The open-hydrolyzed and closed sites are capable of interconversion. Recently, a new type of site that is open-defect involving a tin atom that is bonded to three adjacent silicon atoms through oxygen and a stannol as the fourth bonding partner. The open defect has a missing adjacent silicon atom, resulting in a catalytic site that is distinct from the open tin site.

These defects can be characterized using spectroscopic techniques, including NMR and FTIR of adsorbed deuterated acetonitrile (CD₃CN). For Sn-Beta, the fraction of sites that are open and closed has been measured using FTIR of materials after CD₃CN adsorption. For FTIR of Sn-Beta, the material is dosed with CD₃CN and the spectra is measured, resulting in peaks at 2308 cm⁻¹ for “closed” sites and at 2316 cm⁻¹ for “open defect” sites. These shifts have been corroborated previously using DFT calculations.⁴

NMR has also been used to characterize the Sn species in the zeolite, including ¹¹⁹Sn NMR and ³¹P NMR of materials dosed with trimethyl phosphine oxide (TMPO). Sn NMR has peaks at ˜420 and 440 ppm that correspond to “open-defect” and “closed” sites, respectively. However, Sn NMR is challenging because of the low natural abundance of ¹¹⁹Sn (even when using advanced NMR methods⁵⁻⁸) and the limited incorporation of Sn into the zeolite (˜1-2 wt. %). As an alternative, ³¹P NMR of adsorbed TMPO has recently been identified as a promising method to characterize the Sn species. The ³¹P NMR shifts of TMPO adsorbed to “closed” or “open defect” sites have assigned as peaks in the range of 58.6-57.2 or 54.9-55.8 ppm, respectively (when referenced to phosphoric acid). Interestingly, ³¹P NMR can be performed in a short time and provide quantitative insights on the ratio of open and closed sites. The combination of these spectroscopic methods can be used to characterize defects in zeolites.

The current synthesis methods typically use SnCl₄ as a tin precursor. The synthesis method results in Sn atoms being incorporated into the zeolite in different structures. Based on DRIFTS of deuterated acetonitrile, it is determined that the materials produce a range of open-defect:closed sites of 0.15:1 to 0.4:1. Currently, there is limited to no control over the distribution of sites that are formed.

Additional tin sources have been included in the synthesis, including tin metal, tin acetate, and tin tert-butoxide.^{9,10} These precursors can hydrolyze to form tin species that can incorporate into the framework during crystallization. Interestingly, it is speculated that the remaining cleaved organic group alters the growing dimensions of the crystal.⁹ Whereas the anion affects the morphology, the local environment around the active site is thought to be similar for all of these precursors. An alternative tin source is methyl-tin trichloride. Methyl-Sn-trichloride (CH₃SnCl₃) has seen been seen as a possibility to have increased synthetic control of open/closed sites in the material.¹¹⁻¹³ Whereas SnCl₄ would be able to fully hydrolyze and form four siloxy bonds Sn(—O—Si)₄ in the zeolite framework, CH₃SnCl₃ would likely not be able to. The Sn atom would likely only be able to form three siloxy bonds. Additionally, the methyl group would sterically hinder an adjacent silicon atom from being incorporated into the framework, creating an adjacent defect site.

The inclusion of an alkyl group on the Sn atom could lead to greater synthetic control over material properties, and further knowledge in synthesis-structure-reactivity relationships. The possibility of increasing the number of open Sn sites would be beneficial for the open-site catalyzed glucose isomerization.³ The ability to tune the hydrophobicity is also of great importance as entropically stabilized solvent effects are becoming increasingly evident, as seen in Ti-Beta catalyzed epoxidation.¹⁴ Importantly, the alkyl tin could serve as an important method to tune the local structure of the catalytic site without altering the zeolite framework that is produced.

This work will examine the hydrothermal synthesis of Sn-Beta with different alkyl-Sn precursors (Methyl Sn, n-butyl-Sn, or phenyl-Sn). These resulting materials will be characterized using standard methods, including XRD, nitrogen physisorption, DRIFTS, and 31P NMR. The materials will also be tested for catalytic activity in the alcohol ring opening of epoxides with two different epoxides, including epichlorohydrin and 1,2-epoxyhexane. The observed differences in characterization will be correlated with the differences in catalytic activity to establish synthesis-structure-reactivity relationships for these materials. Overall, the use of alkyl tin precursors will reveal a new method to design the active site in these catalytic materials.

### Experimental Methods

### Hydrothermal Synthesis of Alkyl-Sn-Beta

The synthesis of zeolite Beta with alkyl tin precursors is achieved through a modified procedure reported previously.¹⁵⁻¹⁷ Briefly, tetraethylammonium hydroxide (12.7 g of 35 wt % aqueous solution) is diluted with DI water (25 g). In a glovebox under nitrogen atmosphere, 0.27 mmol of an alkyl tin trichloride (either methyl-SnCl₃, n-butyl-SnCl₃, or phenyl-SnCl₃; exact masses listed in Table 5) is weighed in a vial and dissolved in 1 g of tetraethylorthosilicate (TEOS) and then removed from the glovebox. In a 100 mL round bottom flask, TEOS (10.44 g) is added and mixed with a stir bar, followed by the addition of the diluted TEAOH solution. After mixing for 15 minutes, the TEOS/alkyl-tin mixture is added to the flask and loosely covered with parafilm. After allowing the mixture to hydrolyze for 20 hours, it is rotovapped at 40° C. to just below the target weight, followed by the addition of DI water (10 mL). This is repeated for a total of three cycles to remove ethanol, followed by the addition of water to reach the target weight. The synthesis gel is then split evenly into two Teflon autoclave liners and 0.50 mL of 51 wt % HF solution was added to each reactor, giving a gel composition of 1 SiO₂/0.005 Sn/0.54 TEAOH/0.54 HF/7.5H₂O. It should be noted that the process is sensitive to the amount of HF added. When using accurate and precise methods to add HF to the desired stoichiometry, the overall consistency of the process increased. The need for accuracy is likely one reason that prior work using Me-Sn—Cl₃ did not result in an increase in the fraction of open defect sites.

See Bermejo-Deval, Ricardo, et al., PNAS, 109:25, 9727-9732 (2012). The resulting thick gel is manually stirred with a Teflon rod, and Si-Beta seeds (5% of the expected SiO₂ weight) are added and homogenized. The liner is sealed in stainless steel autoclaves and heated at 140° C. for a certain period of time, around 25 days. The solids are recovered by filtration, extensively washed with water, dried at 100° C. overnight, and finally calcined at 550° C. for 10 h to remove the organic content located in the crystalline material.

TABLE 5
Exact mass of alkyl tin compounds used to synthesize zeolite Beta.

| Chemical | Mass (mg) |
|---|---|
| Methyl tin trichloride | 65 |
| n-butyl tin trichloride | 76 |
| Phenyl tin trichloride | 82 |

### Material Characterization

The materials are analyzed using a series of standard characterization techniques, including nitrogen physisorption, powder X-ray diffraction (PXRD), diffuse reflectance infrared Fourier transform spectroscopy (DRIFTS), diffuse reflectance ultra-violet visible spectroscopy (DRUVS), thermogravimetric analysis-differential scanning calorimetry (TGA-DSC), and elemental analysis.

The crystallinity of the materials is analyzed using PXRD and nitrogen physisorption. Nitrogen physisorption is performed on a Micromeritics 3Flex surface characterization analyzer. The samples are first degassed on a Micromeritics SmartVacPrep sample preparation device at 140° C. under vacuum (10⁻³ mmHg) for 16h followed by an additional in-situ degassing step on the 3Flex for 4 h at 140° C. under vacuum (5×10⁻⁵ mmHg). The nitrogen sorption isotherms of degassed samples are recorded at liquid nitrogen temperatures (˜77 K). The surface area and micropore volume of the materials are reported using BET and the t-plot method, respectively. The PXRD is collected using a Bruker powder X-ray diffractometer in flat plate reflection, Bragg Brentano optics mode using Cu K_{α1}−K_{α2} radiation (λ=1.540 and 1.544 Å) at 40 kV, 40 mA, and room temperature.

DRIFTS analysis is performed using a Nicolet iS50 spectrometer equipped with MCT-A liquid nitrogen cooled detector (32 scans at 2 cm¹ resolution). The DRIFTS set up includes a Praying Mantis (Harrick Scientific Products, Inc.) with a high temperature reaction chamber consisting of zinc selenide (ZnSe) windows. The material is initially degassed in situ at 500° C. for 60 minutes under nitrogen flow. The material is then cooled to 25° C. and pulsed with deuterated-acetonitrile using a VICI 6-port valve equipped with 100 μL sample loop. The probe molecule is allowed to desorb under nitrogen flow while increasing the temperature from 25° C. to 125° C. in steps, holding for 10 minutes at each temperature. The IR spectra are collected using the degassed material at corresponding temperature before dosing as the background. The DRUV-vis spectra are collected on Evolution 300 UV-Vis spectrometer with a resolution of 2 nm at a rate of 10 nm/s with pure silica analogues of materials as the background.

TGA is performed on a STA 449 F5 Jupiter® (NETZSCH instruments) under flowing air (20 mL/min) and nitrogen (20 mL/min; protective gas) at a ramp rate of 10° C./min from 30° C. to 900° C. followed by a 5 min hold at 900° C. The actual weight percent of heteroatom (Sn) substituted in the silica framework in the materials is analyzed by Galbraith Laboratories using inductively coupled plasma-optical emission spectroscopy (ICP-OES).

### Trimethyl Phosphine Oxide (TMPO) Dosing and ³¹P MAS NMR

Trimethyl phosphine oxide (TMPO) is used as a probe molecule to characterize active Sn sites in the Sn-Beta materials. Briefly, 100 mg of catalyst is dehydrated under vacuum at 140° C. overnight. The catalyst is then cooled down to room temperature and a 0.05 wt % of TMPO in DCM is added to reach a desired ratio of 50 mol % of TMPO to total Sn in the catalyst, and allowed to mix overnight. The solvent is then removed by heating the sample back to 140° C. overnight under vacuum. The samples are moved into a glovebox and packed into 7 mm ceramic rotors. The rotors are removed from the glovebox and run on a 600 MHz Bruker NMR for ³¹P MAS NMR.

### Catalytic Testing

The catalytic testing set-up includes a two neck 10 mL round bottom (RB) flask equipped with a condenser, a magnetic stir bar, and a septum. The RB is filled with 2 mL of a solution containing 0.4 M epoxide and diethylene glycol dibutyl ether (DGDE) as an internal standard in neat alcohol. A sample (40 μL) is taken and diluted with acetone (˜2 mL) to serve as the initial concentration data point. The required amount of catalyst is then added to the RB to achieve a 0.4 mol % concentration of Sn (calculated through ICP-OES elemental analysis) in the reaction system. After adding the catalyst, the reaction set-up is immersed in a silicone oil bath that is pre-heated to 60° C. At specific times, a reusable stainless-steel needle is used to draw a sample (40 μL), which is filtered using a small plug of silica and diluted with acetone. The samples are analyzed using gas chromatography (Agilent, 7820A) equipped with flame ionization detector (GC-FID) and the conversion is computed using the internal standard method.

### Results and Discussion

### Material Characterization

Lewis acid zeolites containing tin heteroatoms are successfully synthesized using different tin precursors, including either tin tetrachloride, methyl tin trichloride, n-butyl tin trichloride, or phenyl tin trichloride. After synthesis, the materials are calcined to remove the organic structure directing agent and any additional organic content. The materials are characterized using XRD and nitrogen physisorption.

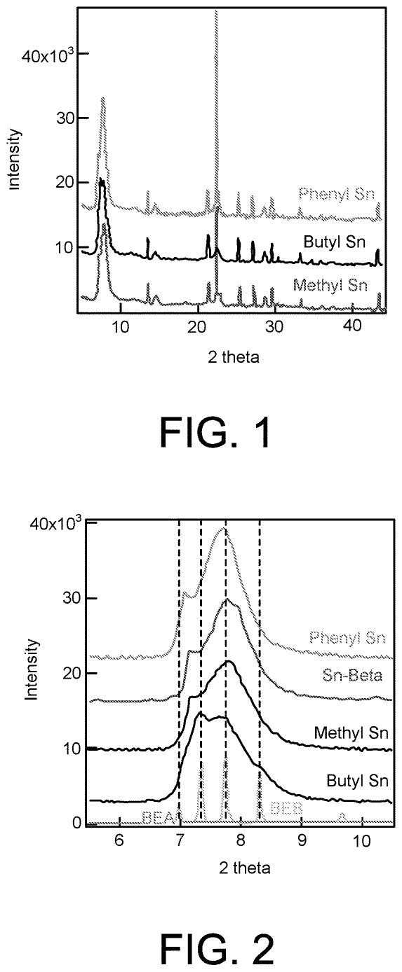

The materials are tested for crystallinity using XRD, as shown in FIG. 1. These catalysts all show well defined peaks consistent with the zeolite beta structure. As the synthesis of zeolite Beta with tetraethylammonium as the SDA produces a distribution of polymorph A, B, and C, the XRD data are examined in the region of 20 of 8°. Interestingly, this 20 region shows that the broad peak around 8° appears to shift and have different structures for the different samples, as shown in FIG. 2. Zeolite Beta itself is an intergrowth of different zeolite polymorphs, predominately polymorph A and polymorph B, and the broadness of this peak at 8° is caused by the intergrowth of these two phases. Therefore, the approximate composition of these two frameworks can be determined for different samples by deconvoluting these peaks. Conventional Sn-Beta is typically thought to have a 45:55 mixture of A:B. Me-Sn-Beta appears to have a similar mixture whereas Ph-Sn-Beta has an enrichment of BEA and Bu-Sn-Beta has an enrichment of BEB. This result is especially interesting because the cause of this difference in bulk framework properties is caused by a change in a very small portion of the synthesis gel. A single alteration of the tin precursor, which account for less than 1 wt % of the final structure, was able to affect the entire zeolite structure.

The materials are further characterized using nitrogen physisorption, TGA, and elemental analysis. As shown in Table 1, the materials are analyzed with nitrogen physisorption. The micropore volume is found to be 0.2 cm³/g, which is consistent with the materials being fully crystalline and have BET surface areas and t-plot micropore volumes typically expected of conventional zeolite beta. TGA confirms that all organics have been removed via calcination, and that all materials have similar bulk hydrophobicity. Elemental analysis through ICP-OES demonstrates that these materials all have similar tin wt % and therefore the tin incorporation efficiencies did not seem to be greatly affected by the different tin precursors, as listed in Table 1.

TABLE 1
Physical properties of Sn-Beta materials.

| | | Surface | Micropore | TGA | |
|---|---|---|---|---|---|
| | | Area | Volume | mass | Open:Closed |
| | Si:Sn^{a} | (m²/g)^{b} | (cm³/g)^{c} | loss^{d} | Sn Sites^{e} |
| Sn-Beta | 212 | 510 | 0.21 | 0.9% | 0.15 |
| Me-Sn-Beta | 242 | 520 | 0.21 | 1.1% | 0.27 |
| Me-Sn-Beta-2 | 234 | 510 | 0.21 | 1.1% | 0.31 |
| Bu-Sn-Beta | 282 | 510 | 0.20 | 1.0% | 0.39 |
| Ph-Sn-Beta | 245 | 520 | 0.20 | 1.1% | 0.32 |

^{a}determined by elemental analysis through ICP-OES.
^{b}determined through BET analysis of nitrogen physisorption isotherms.
^{c}determined through t-plot analysis of nitrogen physisorption isotherms.
^{d}determined through TGA analysis and measuring mass loss from 50-150° C.
^{e}determined through DRIFTS with analysis and measuring mass loss from 50-150° C.

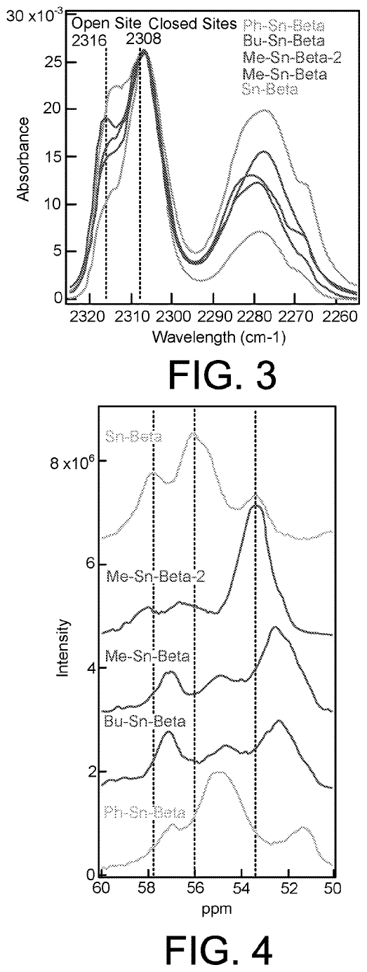

DRIFTS analysis is performed using deuterated acetonitrile as a probe molecule to elucidate specific information on the active Sn sites, as shown in FIG. 3. This technique is conventionally used to determine the ratio of peaks 2316 cm⁻¹ and 2308 cm⁻¹, which are believed to correspond to open Sn sites and closed Sn sites respectively. As the acetonitrile is thought to adsorb preferentially to the Lewis acid sites, the materials are dosed with acetonitrile until the appearance of the peak at 2267 cm⁻¹, indicating the presence of weakly physisorbed acetonitrile, which likely indicates that all other stronger binding sites are saturated. After then it is assumed that all Sn sites in the material are saturated with a single acetonitrile molecule, and the open:closed ratios are calculated, as reported in Table 1. Sn-Beta is typically reported to have an open:closed ratio of about 0.15-0.20:1, and a similar ratio is reported for our material. Me-Sn-Beta appears to have a larger fraction of open sites than Sn-Beta since the ratio of open:closed is 0.27:1. Interestingly, the ratio increases for Bu-Sn-Beta and Ph-Sn-Beta to a value of 0.37:1 and 0.32:1, respectively. These results indicate that the increasing size of the tin precursor tends to result in the formation of more open sites. This suggests that the organic group on the tin molecule is able to displace silicon molecules during synthesis, preventing the completion of Si—O—Si bridges, instead of leaving behind more Si—OH nests near the active site. Whereas TGA results indicate that all materials have similar bulk hydrophilicities, the DRIFTS results suggest that the different materials could have varying hydrophobicity near the Sn site. This could prove to have many catalytic implications as more studies suggest that the chemical environment around active sites play a crucial role during catalysis.

Another technique that can be used to prove the active Sn sites in the material involves performing ³¹P NMR on samples infused with trimethyl phosphine oxide (TMPO). The materials are all degassed and dosed with (TMPO) to reach a theoretical P:Sn ratio of 0.5:1. After drying, the ³¹P NMR is then used to measure the sensitive changes in the chemical environment of the phosphorus molecule as in binds to different acidic sites. The resulting spectra are shown below in FIG. 4. More than two peaks are seen for each material, revealing that there are not just two simple configurations of the TMPO molecule corresponding to open and closed sites.

It is believed that peaks in the lower ppm range correspond to open sites whereas higher peaks correspond to closed peaks. It is also thought that the additional peaks could be caused from multiple TMPO molecules binding to the same Sn center. To simplify quantifiable characterization of these sites, it is assumed that peaks below 54.5 ppm correspond to a single TMPO adsorbing on a single open site and peaks above 54.5 ppm correspond to a single TMPO adsorbing on a single closed site. The validity of these assumption will be tested later, and this is just used as a starting point.

### Kinetic Testing

Through characterization, the materials appear to have different bulk characteristics that may lead to unique catalytic site centers. These materials are tested for catalytic activity using two different epoxide ring opening reactions (ERO) with methanol (MeOH) as the nucleophile; one with a small epoxide, epichlorohydrin (ECH), and one with a large epoxide, 1,2-epoxyhexane (EH). These two different sized epoxides could elucidate further information pertaining to reactant diffusion through the catalyst as well as how the epoxide is able to interact with the available space around the active Sn center.

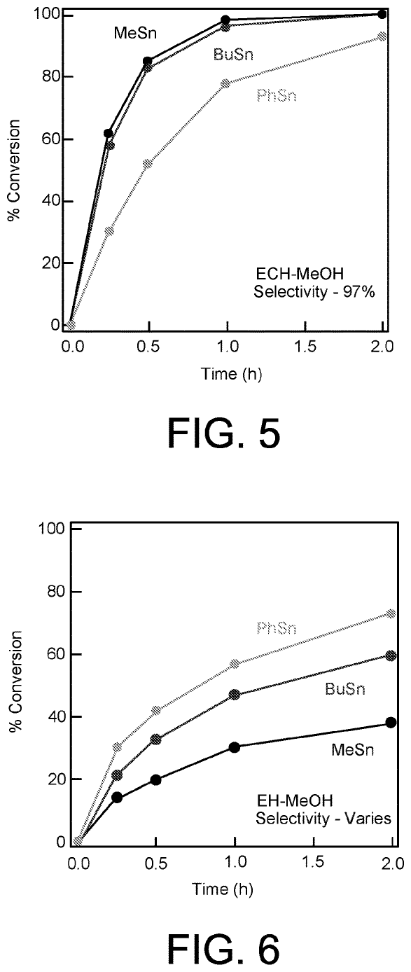

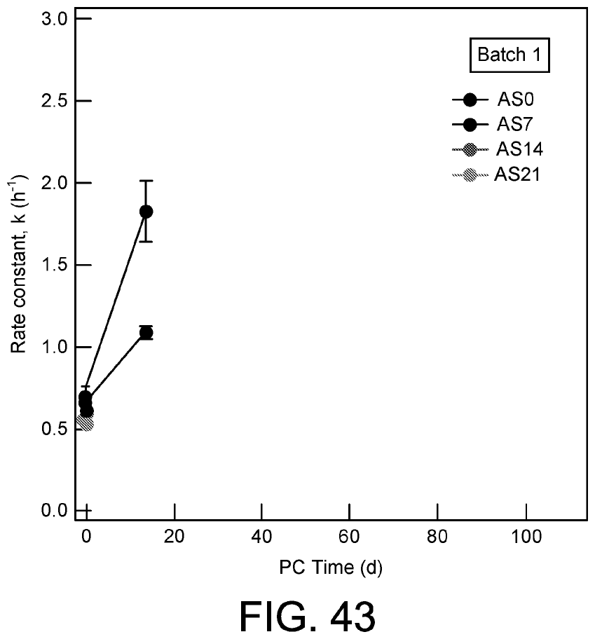

The materials are first tested for ring opening of ECH with MeOH. As seen below in FIG. 5, Me-Sn-Beta appears to have the highest catalytic activity, followed closely by Bu-Sn-Beta and then Ph-Sn-Beta. First order rate constants are calculated and are reported below in Table 2. All catalysts have the same high selectivity of the terminal ether product of 97%. The amount of time after synthesis (AS) and post-calcination (PC) are important. Materials calcined right after synthesis (ASO) have some activity right after calcination PC=0 days. Waiting 14 days before catalytic testing was important to achieving highly active catalysts. In addition, an increase in the activity could be achieved by waiting 7 days (AS7). Again, the higher activity required waiting (in this case 14 days) post-calcination (PC). See FIG. 43.

TABLE 2
Catalytic performance for ERO.

| | | Selectivity | | |
|---|---|---|---|---|
| | Rate | for | Rate | Selectivity |
| | constant | terminal | constant | for |
| | for | ether | for | terminal |
| | ECH-MeOH | ECH-MeOH | EH-MeOH | EH-MeOH |
| | (h⁻¹) | (%) | (h⁻¹) | (%) |
| Sn-Beta | 0.9 | 97 | — | — |
| Me-Sn-Beta | 3.6 | 97 | 0.34 | 52 |
| Me-Sn-Beta-2 | 5.1 | 97 | — | — |
| Bu-Sn-Beta | 3.2 | 97 | 0.61 | 56 |
| Ph-Sn-Beta | 1.5 | 97 | 0.80 | 44 |

The materials are then tested for ring opening of a large epoxide, EH, with MeOH. As shown in FIG. 6, each of these catalysts appear to have lower activity for the larger epoxide, consistent with internal mass transfer of the larger molecule. Interestingly, the trend of the activity of the different catalysts is inverse of the ECH-MeOH results. Ph-Sn-Beta appears to have the highest activity followed by Bu-Sn-Beta and Me-Sn-Beta. The catalysts also have varying selectivity of the products and are reported in Table 1.

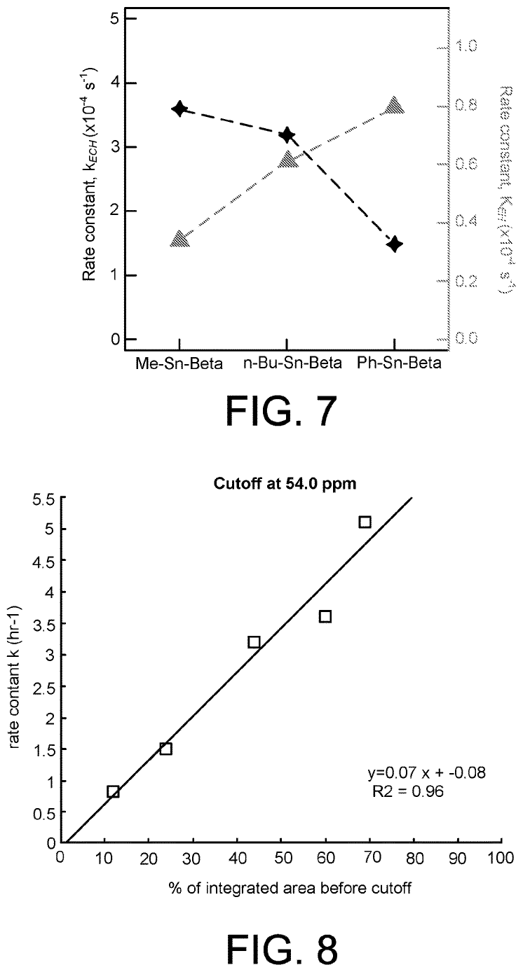

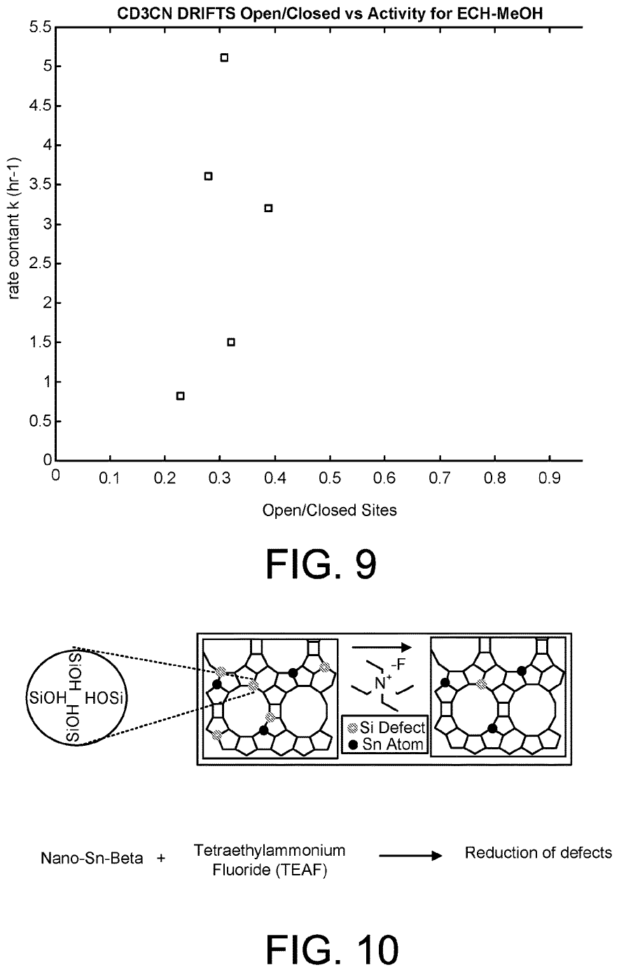

The inverse relationship of these two reactions between the different catalysts is reported below in FIG. 7. This indicates that the ring opening of EH could benefit from the larger defect area caused by the large organic tin precursor.

### Example 2

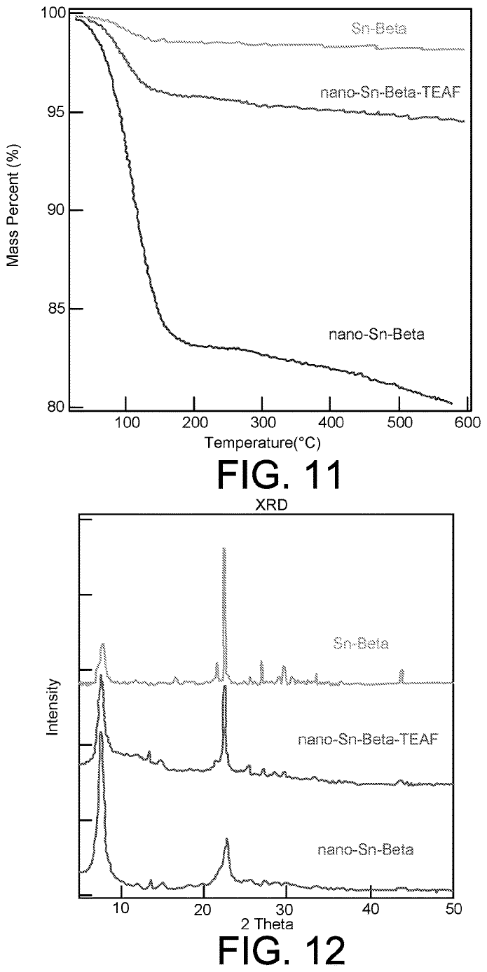

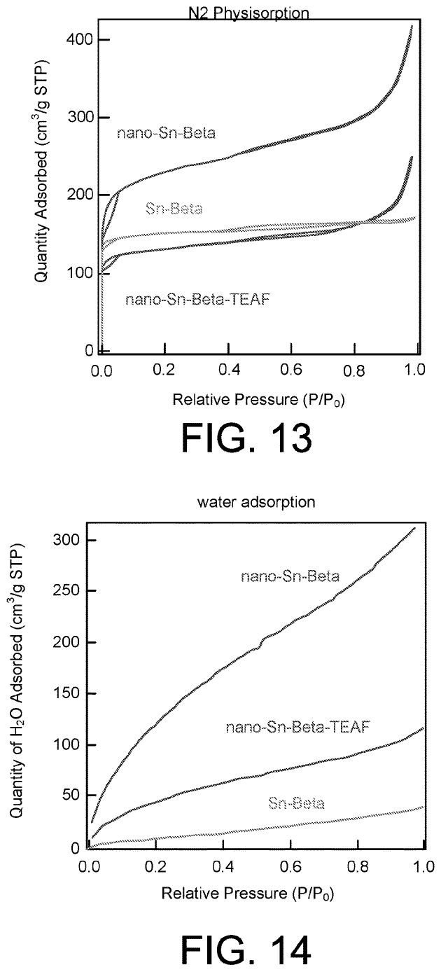

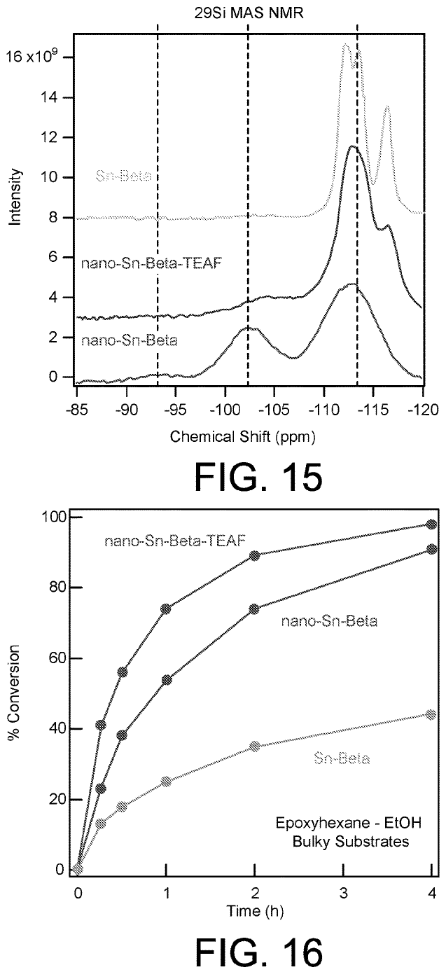

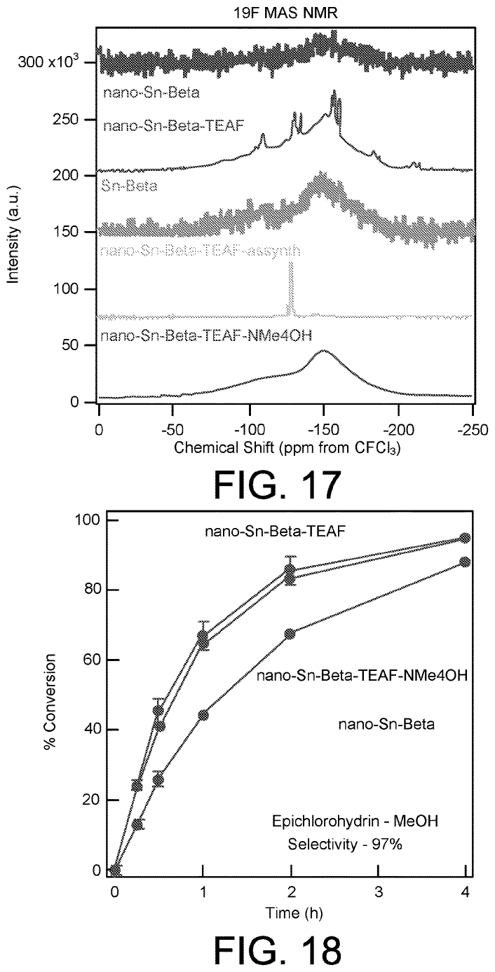

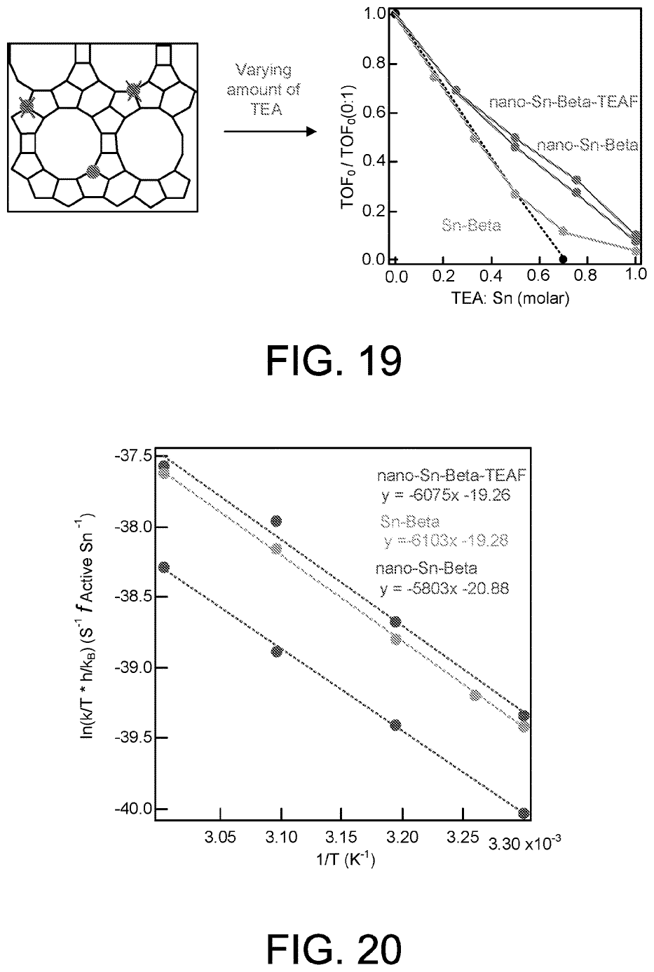

Post synthesis fluoride treatment can reduce silanol defects in Zeolite Beta see diagram in FIG. 10. TGA shows increased hydrophobicity see FIG. 11. Fluoride treatment affects structure properties by maintaining crystallinity as demonstrated in FIGS. 12 and 13 and increasing hydrophobicity as shown in FIGS. 14 and 15. The hydrophobicity effect on epoxide ring opening was tested for small and large substrates. Result is shown in FIG. 16 demonstrate ability to independently tune particle size and hydrophobicity. Improving hydrophobicity improves activity. The treatment also permits retaining nano-sized particles. Residual fluorine shown in FIG. 17 has no effect on activity as demonstrated after NMe₄OH wash to remove fluorine see FIG. 18. Furthermore, fluoride treatment increased number of active sites from 72% to 100% of active Sn as shown in FIG. 19 and Table 4. Eyring Equation was used to calculate activation energies FIG. 20 and Table 3, equation shown below:

$$k = \frac{κ {k}_{B} T}{h} {e}^{\frac{Δ {S}^{t}}{R}} {e}^{- \frac{Δ {H}^{‡}}{RT}}$$

$$ln \frac{k}{T} = \frac{- Δ {H}^{‡}}{R} \cdot \frac{1}{T} + ln \frac{κ {k}_{B}}{h} + \frac{Δ {S}^{‡}}{R} .$$

TABLE 3

| | ΔHₐₚₚ^{‡} | ΔSₐₚₚ^{‡} |
|---|---|---|
| Material | (kJ/mol) | (J/mol*K) |
| Sn-Beta | 50.7 ± 0.7 | −160 ± 2 |
| nano-Sn-Beta | 48.2 ± 1.3 | −174 ± 4 |
| nano-Sn-Beta-TEAF | 50.5 ± 3.4 | −160 ± 11 |

TABLE 4

| | Reaction rate | Reaction rate | |
|---|---|---|---|
| | constant for | constant for | % Active |
| Material | ECH-MeOH (hr⁻¹) | EH-EtOH (hr⁻¹) | Sn Sites |
| Sn-Beta | 0.83 | 0.38 | 72% |
| nano-Sn-Beta | 0.59 | 0.75 | 100% |
| nano-Sn-Beta-TEAF | 1.2 | 1.7 | 100% |

Sn-Beta
${TOF}_{o} = 0.83 {hr}^{- 1} * 250 total Sn {equivalents}^{- 1} * \frac{1. total Sn}{\text{.72} active Sn} = 287 {hr}^{- 1}$ Nano-Sn-Beta-TEAF
${TOF}_{o} = 1.2 {hr}^{- 1} * 250 total Sn {equivalents}^{- 1} * \frac{1. total Sn}{1. active Sn} = 288 {hr}^{- 1}$

This data suggests both hydrophobic materials have similar active sites and reaction environments.

### Example 3: Post Synthetic Incorporation of Ti into Zeolite Beta Via Defect Sites Originating from Methyl-Silanes and its Impacts on Epoxidation and Reduction Reactions

Silanol defects within zeolite frameworks continue to show their importance in bulk material characteristics and overall catalytic performance. Whether by providing locations for new catalytic metal centers to be introduced or by creating a more hydrophilic solvation environment during catalysis, it is valuable to understand how these defects affect different properties and how they could be further engineered to create desired materials. In this work, a novel procedure is used to create controlled defect sites within zeolite Beta using an alkyl silane precursor. Through synthesis of the pure silica zeolite with dilute amounts of methyl silane (Me-Si), vacant defect sites are created at locations where methyl groups sterically hinder the incorporation of silicon atoms during crystallization. Once calcined, the resulting material shows to be significantly more hydrophobic than comparable de-aluminated materials at the same methyl-silane/aluminum loadings, while additionally having the benefit of avoiding harsh conditions such as refluxing concentrated nitric acid to create the defects. Titanium is post-synthetically incorporated into these materials which are then tested for their catalytic performance in the epoxidation of 1-octene and the MPV reduction of furfural to furfuryl alcohol. In both cases, the post-synthetic Ti Me-Si-Beta zeolite behaves more similarly to Ti-Beta synthesized through a hydrothermal route, rather than the typical post-synthetic Ti de-Al-Beta materials. Overall, this work provides a new method to engineer defects within zeolites, opening a new category of possible synthesizable materials.

### Introduction

Zeolites continue to prove their use as valuable materials in the petrochemistry and catalysis industries.^{1,2} Advances in the understanding of their synthesis allows for the production of well-controlled catalysts. Indeed, highly tunable synthesis conditions are able to adapt the desired material properties to specific applications. The ability to perfectly tune the characteristics of the zeolites for their numerous diverse uses will allow them to become an even more prevalent group of heterogeneous catalysts.

Zeolites are a group of crystalline aluminosilicate materials with a framework consisting of T-O-T bonds. These T atoms are typically Al or Si, but other heteroatoms such as Ti or Sn can also be incorporated. As the main catalytic site, these heteroatoms are often the direct focus of catalysis research, with studies such as measuring how increasing the Lewis acid strength of the heteroatom (Hf, Zr, to Sn) affects catalytic performance.^{3,4} However, the surrounding framework around the catalytic site is becoming of higher interest. Complicated proposed reaction mechanisms (i.e., di-nuclear catalytic sites with nearby heteroatoms, heteroatoms with coordinated hydroxyls available for proton transfer, entropic stabilizing effects from local proton bonding networks) suggest that the presence of a single heteroatom is not alone responsible for catalysis, but its exact coordination and local environment play a crucial role as well.⁵⁻⁸ Therefore, elucidating information about synthesis-structure relationships, with the end goal of having a greater control over the tunability of material properties, is crucial to the development of these catalysts.

Currently there are two main categories of procedures used to synthesize zeolites with heteroatoms, hydrothermally or post-synthetically, each resulting in materials with different structural properties.⁹ The first method is a hydrothermal synthesis of the zeolite, where the heteroatoms are incorporated into the silica framework during the initial crystallization. Whereas, typically crystallizing at neutral pH while using fluoride as a mineralizing agent, this synthesis results in a material with few framework defects. However, this comes at the cost of long crystallization times, up to multiple weeks, as the heteroatoms add strain onto the crystallizing framework. This means the hydrothermal synthesis of the zeolite with heteroatoms can often be multiple times longer than synthesis of their pure silicon analogs, especially when high loadings of heteroatoms are desired.

To overcome these issues, another synthesis procedure has been adopted, involving incorporating the heteroatoms into the zeolite framework after crystallization.¹⁰ This post-synthesis incorporation involves first synthesizing a parent aluminosilicate zeolite, often using hydroxide as the mineralizing agent. This permits for a much quicker crystallization, normally a few days, but can often leave framework defects behind in the form of terminal or clustered silanols (Si—OH). The aluminum is then removed from the framework under harsh conditions such as refluxing concentrated nitric acid or elevated temperature steam treatment. This leaves behind defect vacancies in the silicon framework in the form of silanol nests, into which the heteroatoms are then incorporated through solvent assisted or physical mixing of a metal-halide or metal-alkoxide. This results in a material that is believed to be comparable to the hydrothermal synthesis but is able to be synthesized in a fraction of the time.

Upon closer investigation of post-synthetic zeolites, it is evident that their material properties differ significantly from their hydrothermal synthesis counterparts. The materials tend to be dramatically more hydrophilic, as the increased number of silanols can stabilize large clusters of water through hydrogen bonding.¹¹ This has been shown to be very impactful as these solvent effects change the chemical environment around the active sites. This increase in hydrophilicity has been shown to be beneficial for the catalysis of some reactions, such as olefin epoxidation,¹² but detrimental to others, such as glucose isomerization⁶ and epoxide ring opening.¹³ Therefore it is crucial to tune the properties of a zeolite catalyst for a specific reaction.

In addition to differences in hydrophobicity, the two procedures result in materials with different catalytic sites. For hydrothermal syntheses, the dilute amount of heteroatoms are largely believed to be uniformly distributed as isolated incorporated atoms. For post-synthetic materials, the added heteroatoms may form into small nano-clusters in the pores or as extra-framework metal oxides that may exist on the external surface.¹⁴ This distribution of sites is likely the result of the harsh conditions used to remove the original aluminum that can result in a non-uniform structure defects. Different sized silanol nests provide more locations for heteroatom incorporation, and can possibly stabilize larger clusters, not just isolated single atoms. This is undesirable as this lack of control can result in inferior catalytic properties caused by a distribution of metal species. Whereas this post-synthetic approach to make zeolites is useful, it would be desirable to have the ability to tune the defects in the parent material. While alternative methods exist to create defects within zeolites, such as de-silication, de-germination, de-boronation, these methods still rely on acid leaching to remove metal atoms and create defects. It would be valuable to have a procedure to create single defect sites within zeolites while also avoiding treatments that may further alter the framework and defect densities.

Here, a synthesis technique is investigated to create a zeolite structure with well-controlled defects. Pure silica zeolite beta is first synthesized with a small amount of methyl silane, which is then calcined to leave behind defects throughout the material. Titanium is then post-synthetically inserted into these defects using a solvent assisted method. This material is compared to hydrothermally synthesized Ti-Beta as well as a post-synthetic Ti-Beta using de-aluminated zeolite beta as a parent material. The materials are characterized using a host of techniques including XRD and nitrogen physisorption to measure material crystallinity and porosity, water adsorption to measure material hydrophobicity, and FTIR and UV-vis to investigate silanols and titanium within the material. Solid state NMR is used to investigate the structure of the catalysts using a number of techniques including direct ²⁹Si MAS NMR and ³¹P MAS NMR using a probe TMPO molecule. The catalysts are tested using the olefin epoxidation of 1-octene as well as the MPV reduction of furfural. Overall, this work demonstrates a novel synthesis technique to create zeolites with controlled defects. The resulting post-synthetic material has more comparable characteristics to hydrothermally synthesized materials rather than their post-synthetic de-aluminated counterparts. This work furthers the current understandings of structure-reactivity relationships in zeolites and permits for a unique method to engineer defects within zeolites.

### EXPERIMENTAL METHODS

### Synthesis Procedure for Zeolite Materials

### Synthesis of Si-Beta-F

Tetraethylorthosilicate (TEOS) (20.8 g) is added to a 200 mL round bottom flask. Tetraethylammonium fluoride hydrate (TEAF) (9.02 g) is fully dissolved in 40 mL of DI water and slowly added to the TEOS and allowed to mix and hydrolyze overnight. The hydrolyzed mixture is concentrated using a rotovap three times to remove ethanol and some water, adding 5 g of DI water after each rotovapping cycle to aid in removing the ethanol formed during TEOS hydrolysis. DI water is added to the final synthesis gel to achieve the final gel composition. 1 SiO₂: 0.54 TEAF: 7.5H₂O. The synthesis gel is then transferred to a Teflon-lined 45 mL acid-digestion vessel (Parr Inst. Comp.) and calcined de-Al-Beta-OH seeds (300 mg, 5 wt % of target SiO₂) are added to the synthesis gel. The acid digestion vessel is sealed and placed in a preheated oven at 140° C. with rotation at 35 RPM. The material is allowed to crystallize for set number of days. After the necessary crystallization time, the reactor is removed from the oven and quenched under tap water. The formed solids are filtered and washed with 1 L DI water. The filtered solids are dried in an oven at 80° C. overnight and then calcined in air at 550° C. for 10 h to remove the SDA. This material is labeled as Si-Beta-F.

### Synthesis of Me-Si-Beta

A Si-Beta material with defects is synthesized in a similar manner, but adding a portion of methyl trimethoxy silane (MTMOS) with respect to the amount of TEOS, typically 1-4% MTMOS. This results in a material using the following composition 1 TEOS:0.0×MTMOS:0.54 TEAF:7.5H₂O. This material is labeled Me-Si-Beta-0.0×.

### Synthesis of Ti-Beta-F

A hydrothermal Ti-Beta material is synthesized using the same procedure as Si-Beta-F, with the addition of titanium isopropoxide after the aqueous TEAF is added. This results in a material using the following composition 1 TEOS: 0.005 TIPO: 0.54 TEAF: 7.5H₂O. This material is labeled Ti-Beta-0.005.

### Synthesis of Al-Beta-F and De-Al-Beta-F

A hydrothermal synthesis of Al-Beta-F was performed using a similar procedure, with the addition of aluminum nitrate nonahydrate. This results in a material using the following composition 1 TEOS:0.01 Al(NO₃)₃:0.54 TEAF: 7.5H₂O. This material is labeled Al-Beta-F-0.01.

This material is de-aluminated using a concentrated nitric acid procedure. 1.0 g of calcined Al-Beta-F-0.01 is added to a round bottom flask and 56 mL of concentrated nitric acid is added. This was attached to a condenser and lowered into an oil bath pre-heated to 100° C. to mix overnight. This mixture is then allowed to cool, and it is diluted with two volumes of DI water. The mixture is filtered, washed with 1 L of DI water, and dried in an oven for 8 h. After, the material is calcined following the same procedure and is labeled de-Al-Beta-F-0.01.

### Synthesis of Al-Beta-OH and De-Al-Beta-OH

A hydrothermal synthesis of Al-Beta-OH was performed using a similar procedure but with hydroxide ions as the mineralizing agent. 35% TEAOH is diluted with DI water and slowly added to TEOS. Aluminum nitrate nonahydrate is then dissolved in DI water. This results in a material using the following composition 1 TEOS:0.01 Al(NO₃)₃:0.36 TEAOH:13.2H₂O. The resulting material was recovered via centrifugation, repeating multiple times with fresh DI water to wash the material, and then calcined. This material is labeled Al-Beta-OH-0.01.

This material is de-aluminated using the same concentrated nitric acid procedure, with the change that the material is collected and washed via several centrifugation steps. This material is labeled de-Al-Beta-OH-0.01.

Post-Synthetic Incorporation of Ti into Zeolite Defects

Titanium was incorporated into the defects of zeolites originating from either the de-aluminating process (de-Al-Beta-OH, de-Al-Beta-F) or combustion the alkyl groups (Me-Si-Beta), using a wet-impregnation method. First, 1 g of desired, freshly calcined zeolite was weighed into a 100 mL round bottom flask, and then dried under vacuum (<20 mmTorr) at 140° C. for 16 hours. The flask was backfilled with nitrogen, and 20 mL of dry toluene were added. Separately, in a glovebox, 1 g of toluene was weighed into a vial with a septum and appropriate amount of TiCl₄ (typically 0.016 g to reach Si:Ti of 200:1) was dissolved into the toluene, yielding a bright yellow solution. This vial was removed from the glovebox, and the contents were carefully added into the flask containing the zeolites suspended in toluene. This flask was then attached to a condenser and lowered into an oil bath pre-heated to 120° C. This was allowed to mix under reflux for 16 hours and then removed from the oil bath. After allowing it to cool, the flask was removed from the condenser and rotovapped at 40° C. until a dry powder remained. This powder was collected and washed by filtration with methanol and then DI water. The filtered solids are dried in an oven at 80° C. overnight and then calcined in air at 550° C. for 10 h. This material is labeled as ps-Ti_parent-material.

### Characterization Methods

The materials are analyzed using standard characterization techniques, including powder X-ray diffraction (PXRD), nitrogen and water physisorption, diffuse reflectance infrared Fourier transform spectroscopy (DRIFTS), diffuse reflectance ultra-violet visible spectroscopy (DRUVS), elemental analysis (ICP-OES), and 29Si and 31 P MAS NMR.

The crystallinity of the materials is confirmed through PXRD using a Bruker powder X-ray diffractometer in flat plate reflection, Bragg Brentano optics mode using Cu Kα radiation at 40 kV 40 mA, and room temperature.

The porosity of the material is measured using a Micromeritics 3Flex instrument. The samples are first degassed on a Micromeritics SmartVacPrep sample preparation device at 140° C. under vacuum (10⁻³ mmHg) for 16 h followed by in situ degassing of samples on the 3Flex instrument for 4 h at 140° C. under vacuum (5×10⁻⁵ mmHg). The nitrogen physisorption isotherms of degassed samples are recorded at liquid nitrogen temperatures (˜77 K). The water adsorption isotherms of degassed samples are recorded at room temperatures (˜298 K). The surface area and micropore volume of the materials are reported using BET and the t-plot method, respectively.

The weight percent of Ti in each material is measured on an Agilent 5110 ICP-OES. Briefly, 20 mg of material are dissolved in an acid digestion mixture (UA-1, Inorganic Ventures) and then neutralized with a complexing agent mixture (UNS-1, Inorganic Ventures). This mixture is diluted with DI water to reach a final weight of 25 g. The material is then measured against calibrated standards of titanium. DRIFTS is performed using a Nicolet iS50 spectrometer equipped with MCT-A liquid nitrogen cooled detector (32 scans at 2 cm-1 resolution). The DRIFTS set up includes a Praying Mantis cell (Harrick Scientific Products, Inc.) with a high temperature reaction chamber that consists of zinc selenide (ZnSe) windows. The material is initially degassed in situ at 500° C. for 60 minutes under a nitrogen flow before cooling to 25° C. KBr is used as a background when investigating the bare materials. Additionally, measurements are taken with using acetonitrile as a probe molecule to investigate Ti sites, in which case the bare material is used as a background.

The UV-vis spectra are collected on Evolution 300 UV-Vis spectrometer with a resolution of 2 nm at a rate of 10 nm s−1 with barium sulfate as the background at ambient conditions.

29Si (99.3 MHz) NMR and 31P (133 MHz) spectra are collected at 298 K on a Bruker 400 MHz NMR spectrometer by using 4 mm HX probe for magic angle spinning. Samples are spun at 12.5 kHz in 4 mm ceramic rotors. The 29Si chemical shifts are reported relative to tetramethylsilane (TMS) at 0 ppm. The 31P chemical shifts are reported relative phosphoric acid at 0 ppm.

For 29Si NMR, calcined samples are packed into rotors under ambient conditions. For 31P NMR, 200 mg of freshly calcined samples are dried under vacuum (<20 mmTorr) at 140° C. for 16 hours. They are then moved into a glovebox where 2 mL of DCM are added. A specific amount of a dilute solution of trimethylphosphine oxide (TMPO) in DCM is added into the flask and allowed to mix overnight. The samples are removed from the glovebox, and attached to a schlenk line to remove DCM via vacuum. The sample are then added to the glovebox once again to be packed into 4 mm rotor.

### Catalytic Testing

### Octene Epoxidation

Catalytic testing of materials for the epoxidation of 1-octene is performed in a two neck 10 mL round bottom (RB) flask equipped with a condenser, a magnetic stir bar, and a septum. The RB is filled with 2 mL of a solution containing 0.05 M 1-octene and 0.01 M toluene (internal standard) in acetonitrile. 108 μL of a 30 wt % hydrogen peroxide solution (measured to be 28.3% through a titration with potassium permanganate under acidic conditions) is added to the mixture, overall resulting in a final concentration of 0.5 M H₂O₂. An initial sample (40 μL) is taken and diluted with acetone (˜2 mL) to serve as the initial concentration data point. The required amount of catalyst is then added to the RB to achieve 2.5 mol % Ti:alkene. After adding the catalyst, the RB is immersed in a silicone oil bath, pre-heated to the desired temperature of 40° C. At specific times, a sample (40 ILL) is withdrawn from the reaction mixture using a reusable stainless-steel needle and is filtered using a small plug of silica and diluted with acetone. The samples are analyzed using gas chromatography (Agilent, 7820A using Restek RTX 5 MS column) equipped with flame ionization detector (GC-FID), and the conversion is computed using the internal standard method. Calibration standards of 1,2 epoxyoctane are used to measure the selectivity of the reaction following:

$${Selectivity}_{EO} = \frac{mols of epoxyoctane produced}{mols of octene consumed}$$

$${Selectivity}_{EO} = \frac{mols of epoxyoctane produced}{mols of all detected products}$$

Consumption of H₂O₂ is measured through a colorimetry measurement with copper sulfate and a chelating agent. Briefly, in a cuvette, 0.3 mL of 0.01 M copper sulfate aqueous solution, 0.3 mL of 0.04 M neocuprione in ethanol solution, 0.3 mL of a phosphate buffer solution (adjusted to a pH of 7 using mono and dibasic sodium phosphate) and 2.1 mL of DI water are added. Separately, a 40 μL sample is taken from the reaction mixture and diluted into 5.0 mL of DI water. 40 μL of this diluted mixture is then added to the cuvette and shaken for 5 seconds. The sample is then measured on an Evolution 300 UV-Vis spectrometer, and the intensity at 454 nm is taken and compared against a calibration curve to determine the concentration of H₂O₂ in the original reaction mixture.

### MPV Reduction of Furfural

Catalytic testing of materials for the reduction of furfural using isopropanol as a sacrificial alcohol is performed in a 5 mL pressure tube. A reaction mixture is created by mixing 18 mL of dry isopropanol, 90 μL of freshly distilled furfural, and 112 mg of 1,3,5 trimethoxybenzene as an internal standard. 2 mL of the solution is added to the pressure tube and an initial sample (40 μL) is taken and diluted with ether (˜2 mL) to serve as the initial concentration data point. The required amount of catalyst is then added to the RB to achieve a 4 mol % Ti: furfural. After adding the catalyst, the RB is immersed in a silicone oil bath, pre-heated to the desired temperature of 100° C. At specific times, the pressure tube is removed from the oil bath, cooled in an ice water bath, and a sample (40 μL) is withdrawn from the reaction mixture using a micropipette and is filtered using a small plug of silica and diluted with ether. The samples are analyzed using gas chromatography (Agilent, 7820A using Restek RTX 5 MS column) equipped with flame ionization detector (GC-FID), and the conversion is computed using the internal standard method. GC-MS was used to identify products of reaction. Calibration standards of products 2, 3, and 4 are used to determine yields of each product.

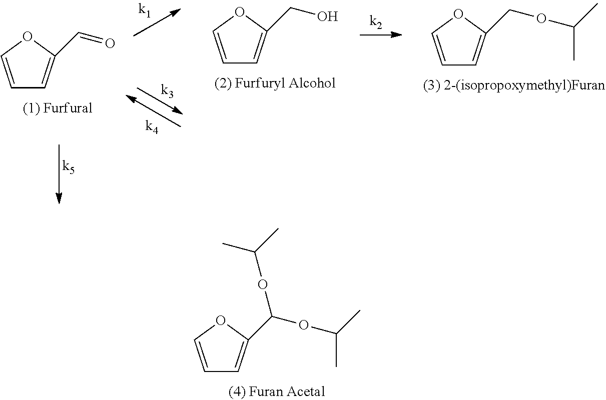

(5) by-Products (Polymerization Products)

To measure experimental rate constants for the different reactions presented in Scheme 1, the measured concentrations of each species were fitted in Matlab using lsqcurvefit and ode45 functions to fit a model with five rate constants.

### Results and Discussion

### Synthesis of Me-Si-Beda

A material is synthesized through adding a small amount (1-4 mol %) of a methyl silane in the synthesis of a pure-silica zeolite Beta. It is proposed that the alkyl group would sterically hinder the incorporation of a nearby silicon atom during crystallization, not only preventing a Si—O—Si linkage, but also creating a silanol nest in its stead. The Si—C bond is expected to resist hydrolysis during the hydrothermal synthesis conditions under neutral pH conditions.¹⁵ After crystallization, the material is calcined to combust both the OSDA and the alkyl group, leaving behind a pure silicon framework, with single defect sites (silanol nests) where the alkyl silane previously resided.

This synthesis method is contrasted with the typical synthesis method to create zeolites with defects, namely de-aluminated zeolites. Treating aluminum zeolites with concentrated nitric acid has been shown as an effective way to create defects in zeolites, which could later be used to post-synthetically incorporate other heteroatoms. However, the harsh conditions to remove the Al atoms is likely to have unintended effects, namely further hydrolysis of the crystalline framework. This has the consequence of creating not only a very hydrophilic environment, but also creating different sized defects throughout the material. Dai et al. demonstrated a variety of Sn species within a host of post-synthetic de-Al-Beta materials, revealing differences through spectroscopy methods and Lewis acid catalyzed reactions.¹⁴ While previously it was believed that only isolated tetrahedral Sn atoms provide catalytic Lewis acidity, it was shown that octahedral coordinated SnO₂ clusters of small sizes can also provide considerable amounts of Lewis acidity which then decreases with increasing cluster size. This further reveals the importance of being able to have greater control of defects within zeolites to create materials with uniform catalytic properties.

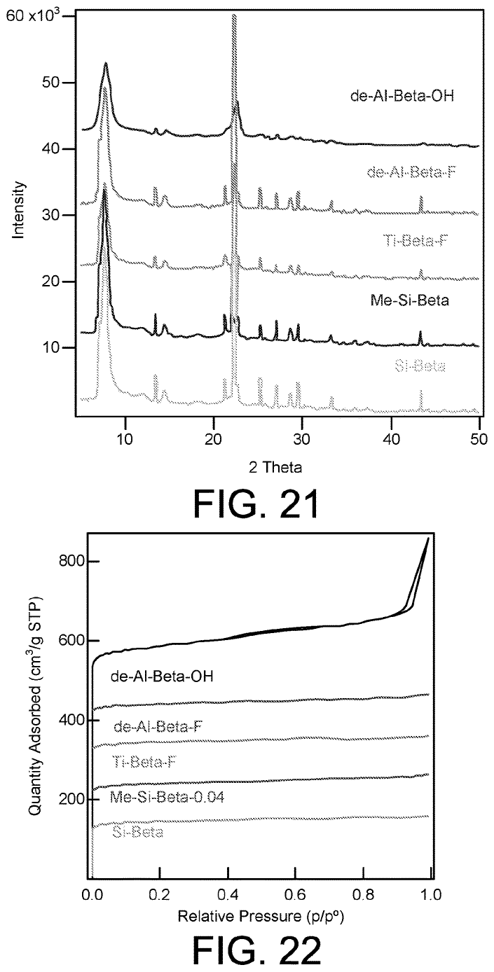

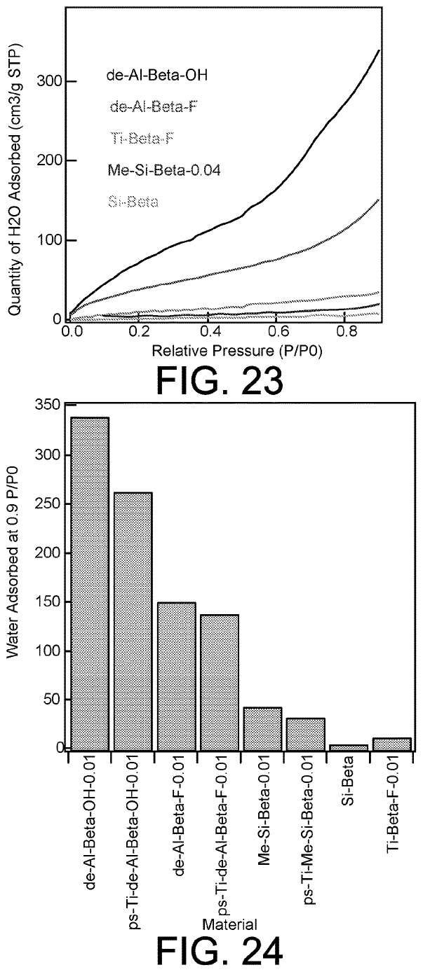

Me-Si-Beta was synthesized and compared to that of a typical pure Si-Beta, as well as more common defect zeolites, de-Al-Beta-OH and de-Al-Beta-F, at similar defect loadings (equal molar amounts of methyl silane or aluminum). As shown in FIG. 21, XRD plots reveal that all materials are consistent with the Beta framework. Additionally, the broader peaks of de-Al-Beta-OH follow the expectation of significantly smaller particle sizes created through hydroxide mediated conditions.¹⁶ All of the materials demonstrate expected levels of porosity through nitrogen physisorption measurements (values reported in Table 6, isotherms in FIG. 22), further corroborating that all materials possess the crystalline Beta framework.

The hydrophobicity of the materials is measured through water adsorption to provide insight about defects throughout the frameworks. Pure Si-Beta exhibits high levels of hydrophobicity and adsorbs limited amounts of water. The de-Al-Beta materials adsorb large quantities, and as expected, de-Al-Beta-OH adsorbs significantly more water than its de-Al-Beta-F counterpart, revealing that the hydroxide mediated synthesis conditions lead to more hydrophilic materials than fluoride mediated conditions. Me-Si-Beta interestingly appears to be only slightly more hydrophilic than Si-Beta, while containing theoretically similar amounts of defects as the de-Al-Beta samples. This is consistent with the idea that small isolated clusters of silanols would not be able to stabilize large clusters of water.

TABLE 6
Characterization data for materials.

| | Starting | | | BET | t-plot |
|---|---|---|---|---|---|
| | Si:X | Tar- | Actu- | Surface | micropore |
| | where X is | get | al | area | volume |
| Material | Al or MeSi | Si:Ti | Si:Ti^{a} | (m²/g)^{b} | (cm³/g)^{b} |
| PS-Ti-de-Al-Beta- | 100 | 200 | 189 | 640 | 0.25 |
| OH-0.01 | | | | | |
| PS-Ti-de-Al-Beta- | 100 | 200 | 205 | 530 | 0.21 |
| F-0.01 | | | | | |
| PS-Ti-MeSi-Beta- | 100 | 200 | 354 | 520 | 0.21 |
| 0.01 | | | | | |
| PS-Ti-MeSi-Beta- | 50 | 200 | 285 | 510 | 0.20 |
| 0.02 | | | | | |
| PS-Ti-MeSi-Beta- | 25 | 200 | 250 | 490 | 0.19 |
| 0.04 | | | | | |
| Ti-Beta-F | — | 200 | 211 | 510 | 0.20 |
| PS-Ti-Si-Beta | — | 200 | 432 | 530 | 0.21 |

^{a}Determined from ICP-OES measurements to determine Ti wt %.
^{b}Calculated from the nitrogen adsorption isotherm.

TABLE 7
Comparison of material properties.

| | | | | Quantity |
|---|---|---|---|---|
| | Theoretical | | | of water |
| | Defect:Si | ΦIsolated | ΦNests | adsorbed |
| de-Al-Beta-OH- | 1% | 0.51 | 4 | 341 |
| 0.01 | | | | |
| de-Al-Beta-F-0.01 | 1% | 0.04 | 1.1 | 148 |
| Me-Si-Beta-0.04 | 4% | 0.027 | 0.18 | 49 |
| Me-Si-Beta-0.01 | 2% | 0.015 | 0.112 | — |
| Me-Si-Beta-0.01 | 1% | 0.011 | 0.065 | — |
| Si-Beta | 0 | 0.008 | 0.095 | 8 |

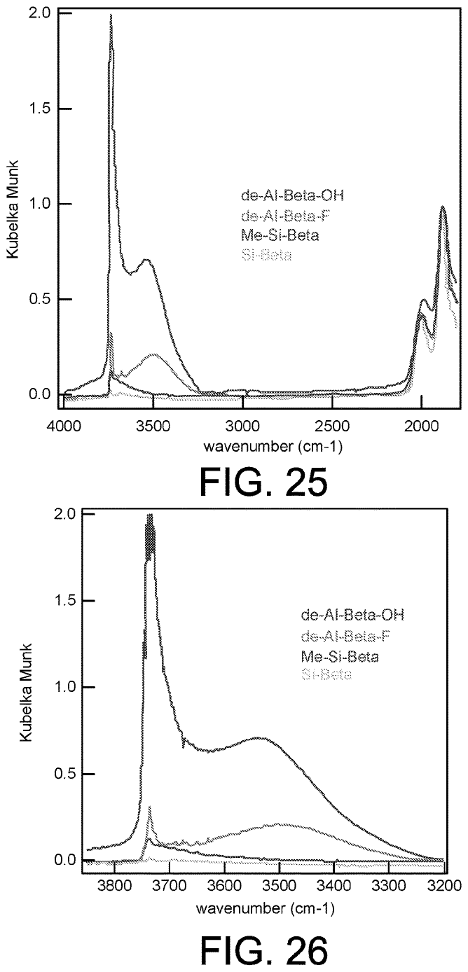

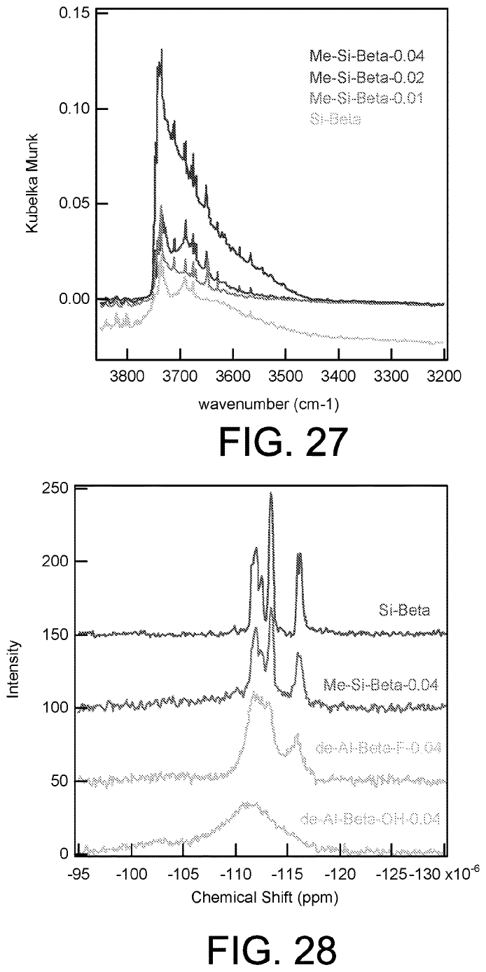

To further investigate the nature of these defects throughout the materials, FTIR measurements are used to observe different silanol species see FIGS. 25-27. The hydroxyl stretching region (4000 cm⁻¹ to 3000 cm⁻¹) are analyzed on dehydrated samples, that are then normalized by their v(Si—O—Si) overtones at 1890 cm⁻¹. The hydroxyl region is then split into two main categories, a sharp peak at 3750 cm¹ and a broad peak stretching from 3700 to 3300 cm⁻¹, associated with isolated silanols or hydrogen bonded silanols, respectively. The isolated silanols are largely believed to be on the terminal surface of the crystal, but it may also exist a silanols within the framework that have limited interaction with other species. The broad peak is associated with a wide distribution of hydrogen bonded species, caused by near proximity of groups of silanols. The ratios of these different species are measured as the ratio of the area of the specific group to the area of v(Si—O—Si) to gather information about defects in the materials.

The de-Al-Beta samples once again show larger quantities of both isolated and grouped silanols. The increased amount of isolated silanols in de-Al-Beta-OH is explained by the smaller particle size which creates a larger external surface area for terminal silanols. However, the increased amount of group silanols is once again evidence that the hydroxide mediated synthesis conditions lead to a material with defects all throughout the material. At a similar quantity of defects, Me-Si-Beta reveals to have a dramatically decreased amount of grouped silanols compared to de-Al-Beta-F, while having a much smaller difference in the amount of isolated silanols. This supports the hypothesis that defects caused by the synthesis with Me-Si leads to more isolated silanols rather than larger connected networks. Larger amounts of Me-Si lead to increasing amount of silanols at higher wavenumbers, but no broad peaks around 3500 cm¹ are observed.

Lastly, direct polarization ²⁹Si MAS NMR is used to investigate silicon species throughout the materials see FIG. 28. Pure Si-Beta demonstrates a few sharp peaks from −110 to −118 ppm, reflecting the nine different crystallographic T sites where a silicon atom can exist in the Beta framework. Me-Si-Beta exhibits a very similar spectra, albeit with slight line broadening. This is representative of the existence of similar species, but with slight modifications of their local environments, likely caused by the distribution of isolated defects. De-Al-Beta-F exhibits significantly stronger line broadening, caused by drastic disruptions in the crystalline structure. The spectra of De-Al-Beta-OH degenerates into a single large broad peak around −111 ppm associated with Q₄ species, along with the new addition a smaller board peak around −103 ppm associated with Q₃ species, revealing a very defective material.

Overall, these measurements reveal that a pure Si zeolite beta framework is able to be synthesized with dilute amounts of methyl silane to create a material with fewer defects than similar de-Al-Beta materials. This could be promising approach to incorporated isolated heteroatoms post synthetically while maintaining a hydrophobic material.

Incorporation of Ti into Ae-Si-Beta

After characterizing defects in Me-Si-Beta and de-Al-Beta materials, titanium is then incorporated using a wet impregnation method in refluxing toluene. In order to limit the formation of large extra framework clusters of TiO₂ and to promote the preferential formation of isolate Ti sites, a half equivalence of TiCl₄ is added with respect to the molar amount of expected defects. After recovering the materials, the amount of total Ti and Al in the materials is measured through ICP-OES. For de-Al-Beta-OH and-F, it is shown that the nitric acid de-alumination procedure is sufficient to remove all of the aluminum, to below detectable amounts of 6000:1 of Si:Al. The actual amount of titanium incorporated into these materials is very close to the theoretical amount added, suggesting that there are sufficient locations for the Ti atom to react with. For Me-Si-Beta, a much lower incorporation efficiency is observed. This could indicate that there are not enough locations for the TiCl₄ to react with, or that it is reaction is more inhibited. In order to compare catalytic materials at similar Ti loadings, the post-synthesis incorporation procedure is repeated on Me-Si-Beta materials with larger starting quantities of starting defects. Only by using a starting Me-Si-Beta-0.04, was a similar Ti loading compared to de-Al-Beta. The post-synthesis procedure was also used on a pure Si-Beta material to use as a control material. This material does show to have some Ti, but significantly lower than expected.

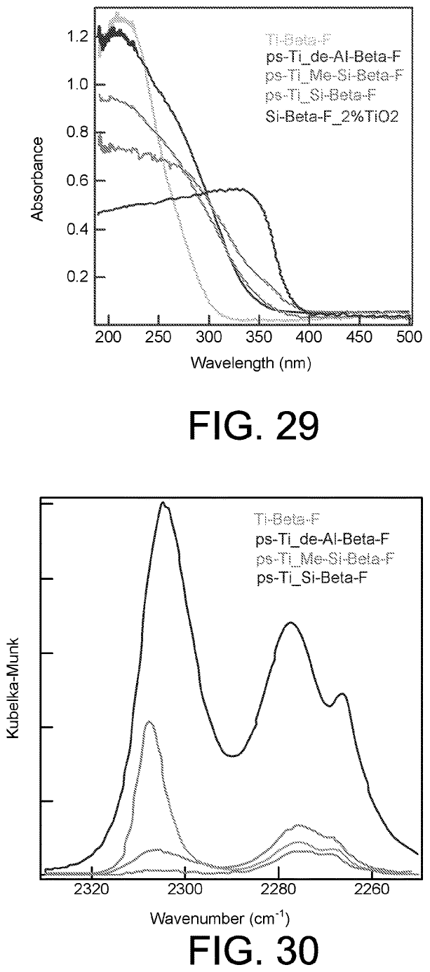

The Ti species are characterized using UV-vis see FIG. 29, FTIR with adsorbed with acetonitrile as a probe molecule, and ³¹P MAS NMR using TMPO as a probe molecule. UV-vis of the ps-Ti materials are first measured to look at the coordination state of Ti within the materials. Hydrothermally synthesized Ti-Beta-F exhibits a single peak at 210 nm, representative of isolated tetrahedral coordinated Ti atoms. This is contrasted with a physical mixture of 2 wt % TiO₂ anatase with pure Si-Beta, which shows broad absorbance up to 340 nm. All of the post-synthetic materials (de-Al-Beta, Me-Si-Beta, and Si-Beta) show similar absorbance spectra, with a large peak at 210 nm with a shoulder stretching to 300 nm. Ps-Ti-Si-Beta reveals a larger absorbance to 350 nm, indicating the likelihood of the formation of larger TiO₂ extra framework clusters. Ps-Ti-de-Al-Beta-F and ps-Ti-Me-Si-Beta appear very similarly, with the peak of de-Al-Beta-F being stronger, correlating with higher amounts of overall Ti incorporation. Outside of this, it is hard to draw strong conclusions about the nature of Ti species within the materials from UV-vis measurement alone.

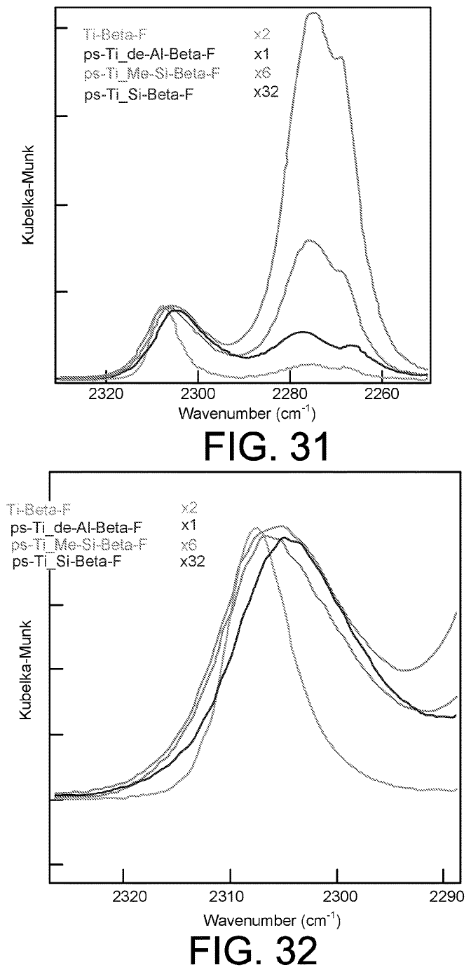

To measure the acidity of the catalysts from incorporated Ti, FTIR measurements of the samples are taken using acetonitrile as a basic probe molecule. The samples are first dehydrated in flowing nitrogen, and then acetonitrile is dosed through a bubbler. Acetonitrile is continually dosed until a peak is seen at 2268 cm-1, associated with physisorbed acetonitrile. The observation of this peak indicates the saturation of all stronger binding sites including Ti (2308 cm⁻¹) or weakly acidic silanols (2275 cm⁻¹). After normalizing the spectra to the Ti-ACN peak at 2308 cm⁻¹, all peaks exhibit similar shape and location. Ti-Beta-F exhibits the sharpest peak close to 2309 cm⁻¹, while the other peaks are slightly broader and centered around 2308 cm⁻¹. The similarity of the peaks make it difficult to discern about the possibility of a distribution of Ti species present. Rather, this may indicate that each of these materials contain some fraction of Ti sites that display sufficient Lewis acidity to adsorb acetonitrile. See FIGS. 30-32.

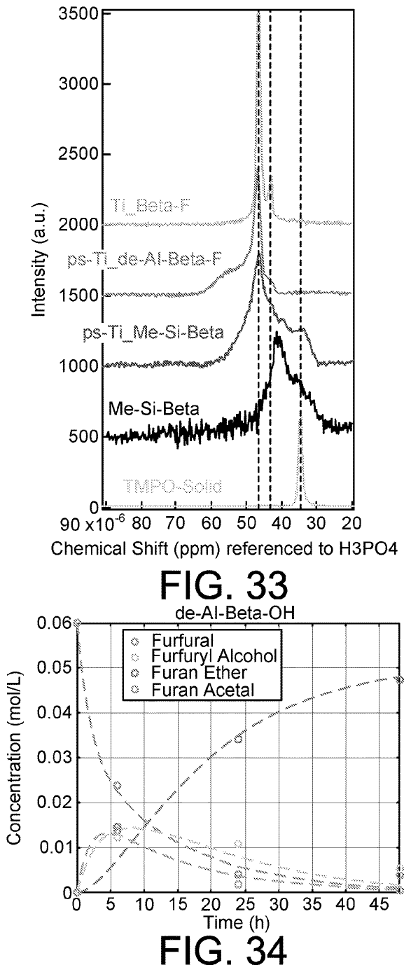

Another spectroscopy technique, ³¹P MAS NMR with TMPO (see FIG. 33), is used to elicit more information about the acidity of incorporated Ti. ³¹P NMR is a powerful technique as the chemical shift of the ³¹P nuclei is very sensitive to changes to binding strengths and local chemical environments.¹⁷ All of the materials are dehydrated before an addition of TMPO in DCM. TMPO is added in a theoretical amount of 50% TMPO to Ti in order to promote isolated adsorption of single TMPO molecules to Ti atom centers. Solid TMPO is first measured and shows a single sharp peak at 35 ppm. TMPO on Ti-Beta-F exhibits one sharp peak at 46 ppm and a second smaller peak at 44 ppm. These peaks may correlate to closed and open Ti sites within the catalyst, but further investigate or speculation into these specific sites is outside of the scope of this work. Ps-Ti-de-Al-Beta shows the similar main Ti peak at 46 ppm, but also includes a broad peak ranging from 60 ppm to 40 ppm. It is hypothesized that the broad peak represents a distribution of Ti species and contains different sized Ti clusters. Ps-Ti-Me-Si-Beta exhibits a similar main Ti peak at 46 ppm, but also contains a broader shoulder from 45 ppm to 35 ppm. Measuring TMPO adsorbed on the pure silicon Me-Si-Beta parent material reveals that this broad shoulder is likely caused by TMPO interacting with silanols or surface of the material, and not necessarily associated with the active Ti centers. Similar spectra are observed on pure Si-Beta and parent de-Al-Beta materials. The broad shoulder observed on ps-Ti-Me-Si-Beta is likely caused by a high ratio of actual TMPO to Ti, as the measured amount of Ti incorporated into this material is dramatically lower than theoretically expected. Altogether, these results suggest that the Lewis acidic Ti incorporated into Me-Si-Beta tend to primarily be isolated Ti sites, similar to the hydrothermal counterpart, while Ti incorporated into de-Al-Beta materials form an additional distribution of Ti sites.

### Catalytic Testing of MPV Reduction of Furfural

The catalytic implications of Ti post-synthetically incorporated into Me-Si-Beta is first measured through the MPV reduction of furfural to furfuryl alcohol. Furfural is an important biomass platform molecule, and converting it to other valuable products at high selectivity is imperative. Using the MPV reaction to reduce furfural instead of other hydrogenation methods prevents over hydrogenation totetrahydrofuran products. However, product selectivity is still a concern as the sacrificial alcohol can lead to side products via addition reaction pathways, such as ethers or acetals (see Scheme 1). Therefore, monitoring the production of these molecules over different catalysts can provide information about the catalytic sites and their chemical environments.

The MPV reduction of furfural in isopropanol is carried out in batch reactors, first using ps-Ti-de-Al-Beta-OH as a catalyst. The concentration of each species is monitored over time. At the first time point, similar amounts of furfuryl alcohol, furan isopropoxy-ether, and furan di-isopropoxy acetal are all produced. Over time, the starting furfural, the desired alcohol and the acetal are all consumed to produce primarily the over reacted ether product. To quantify the reaction rates, a model is created following Scheme 1, and a least squared fits is used to calculate observed rate constants. In particular, rate constants k₁ and k₂ are of most interest as these appear to be primarily forward reactions in series. A parallel reaction 3 appears to be at an equilibrium with the starting furfural. This acetal is observed to be formed in dilute amounts in a reaction mixture with no catalyst, and is produced in higher quantities using a pure Si-Beta catalyst. Reaction 4 is added to account for undetectable polymerization products, but this is observed to be significantly slower in comparison to the others. Therefore, a ratio of the k₁ and k₂ can provide meaningful information about the selectivity over a given catalyst, and for ps-Ti-de-Al-Beta-OH, this ratio is quite low. See FIG. 34.

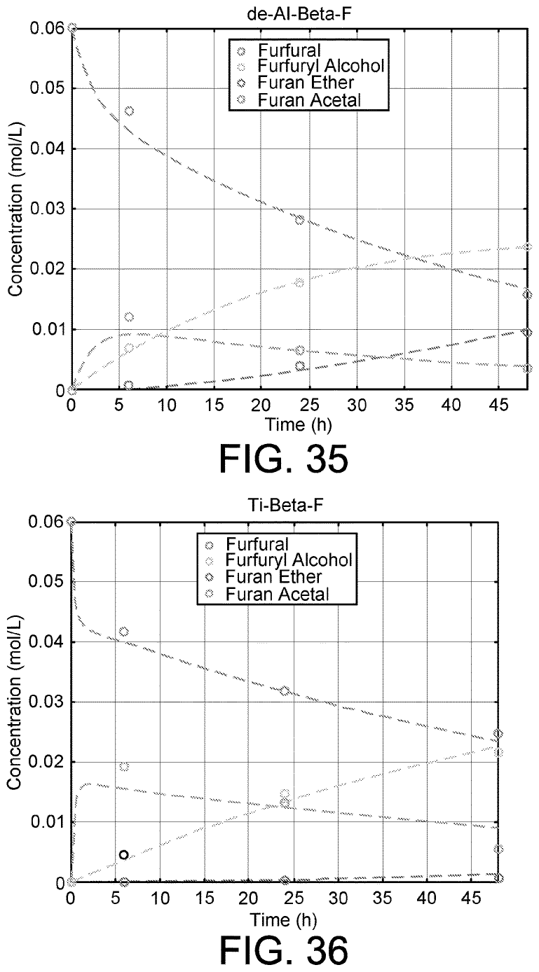

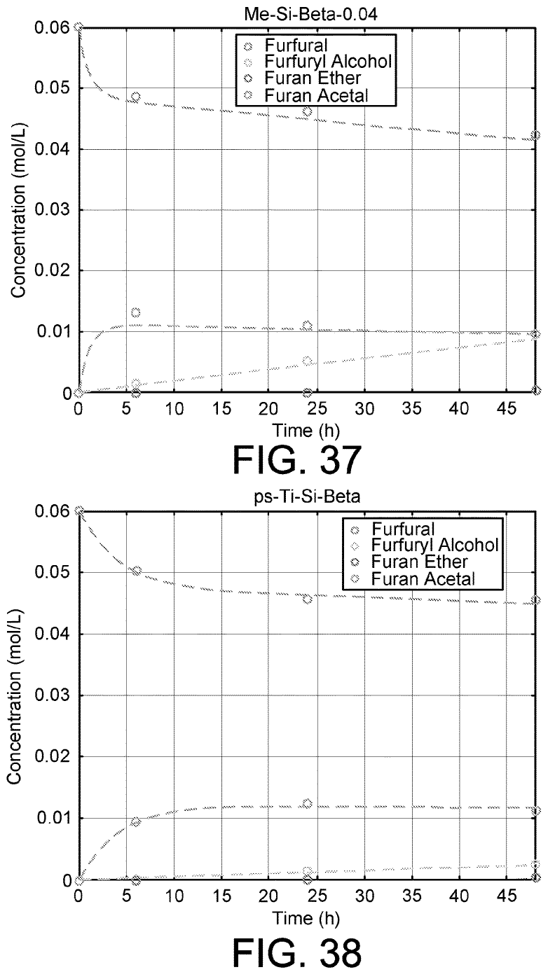

The ps-Ti-de-Al-Beta-F catalyst appears to catalyze all reactions slower, but the ratio of k₁/k₂ shows to have slightly higher performance to the desired alcohol product. Hydrothermal Ti-Beta-F demonstrates similar rate of reactions for the alcohol product, but leads to almost no ether formation, giving a high k₁/k₂. Ps-Ti-Me-Si-Beta leads to similar selectivity as Ti-Beta-F, yielding almost no ether product, but it does have a lower ovel activity. Using a ps-Ti-Si-Beta catalyst as a control yields almost no products other than the acetal. From a brief comparison of k₁/k₂ for the different catalysts, it appears that Ti-Beta-F and ps-Ti-Me-Si-Beta have the highest selectivity to the furfuryl alcohol product. See FIGS. 35-38.

Further control tests are used to corroborate the above observations. Both parent pure silicon de-Al-Beta materials are used as catalysts to see if the parent framework is the cause of the ether formation, possibly catalyzed by remnant aluminum or hydrogen bonding silanol nest networks. Using the catalysts in a reaction mixture with starting furfural leads to only the acetal product, while a reaction mixture with starting furfuryl alcohol leads to no reaction. Using the starting Al-Beta catalysts leads to the hydrodeoxygenation product of 2-methyl furan, which is not observed in any other reaction with titanium. These measurements lead to the conclusion that the post-synthetic incorporation of Ti into de-aluminated materials creates a catalyst with a different reaction environment than the conventional hydrothermal Ti-Beta-F leading to the selectivity differences.

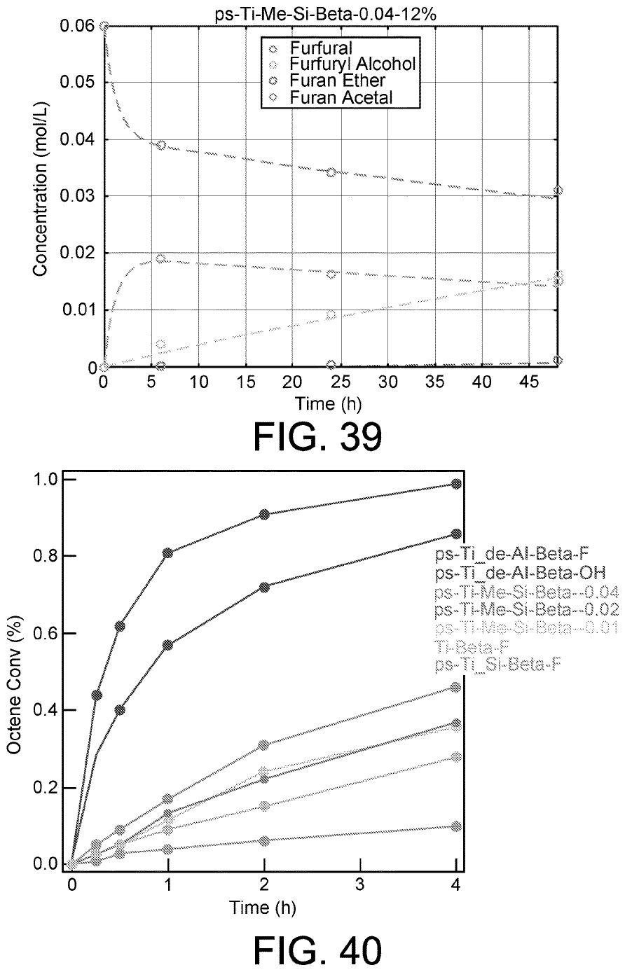

The limited activity of ps-Ti-Me-Si-Beta is further tested by using a higher molar percentage of catalyst. In initial tests, very little ether is produced, but this could be caused by slow formation of the alcohol product, giving a skewed representation of the high selectivity of the reaction. By tripling the amount of catalyst added (to 12 mol %), higher conversions to furfuryl alcohol are observed with limited overreaction to the ether. This test gives similar results in activity and selectivity as Ti-Beta-F, but at a much higher amount of total Ti atoms present. This discrepancy is likely representative of the fact that not all Ti in the Me-Si-Beta catalyst is active. A control test with a physical mixture of Si-Beta and 2 wt % TiO₂ anatase leads to only the acetal product, showing that large clusters of TiO₂ appear inactive for the reaction. These results altogether indicate that the catalytically active sites in ps-Ti-Me-Si-Beta behave more similarly to Ti-Beta-F than they do to similar ps-Ti-de-Al-Beta defect materials. See FIG. 39.

TABLE 8
Comparison of the calculated reaction rate constants
for the MPV reduction with different catalysts.

| (10⁻³) | k₁ | k₂ | k₃ | k₄ | k₅ | k₁/k₂ |
|---|---|---|---|---|---|---|
| PS-Ti de-al-Beta-F | 23 | 13 | 80 | 390 | 4 | 1.8 |
| PS-Ti de-al-Beta-OH | 101 | 128 | 150 | 310 | 17 | 0.8 |
| Ti-Beta-F | 15 | 2 | 770 | 2000 | 2 | 6.7 |
| PS-Ti Me-Si-beta-0.04 | 4 | 1 | 160 | 710 | 0.01 | 7.3 |
| PS-TiMe-Si-beta-0.04 12% | 9.6 | 1.5 | 260 | 540 | 0 | 6.25 |
| Si-Beta | 1 | 3 | 50 | 190 | 0.3 | 0.4 |

### Catalytic Testing of 1-Octene Epoxidation

The catalytic performance of these Ti materials are then compared in a more typical epoxidation reaction, specifically of 1-octene using hydrogen peroxide in acetonitrile. Previous literature supports the idea that more hydrophilic Ti-Beta is more active for this reaction via positive entropic effects caused by reactant transition states disrupting hydrogen bonded water networks.^{12,18} These works primarily use ps-Ti-de-Al-Beta-OH is to show a dramatic increase in activity over Ti-Beta-F. Presently, we seek to additionally compare the ps-Ti-Me-Si-Beta and ps-Ti-de-Al-Beta-F, which are both more hydrophobic than the conventional hydroxide mediated material.

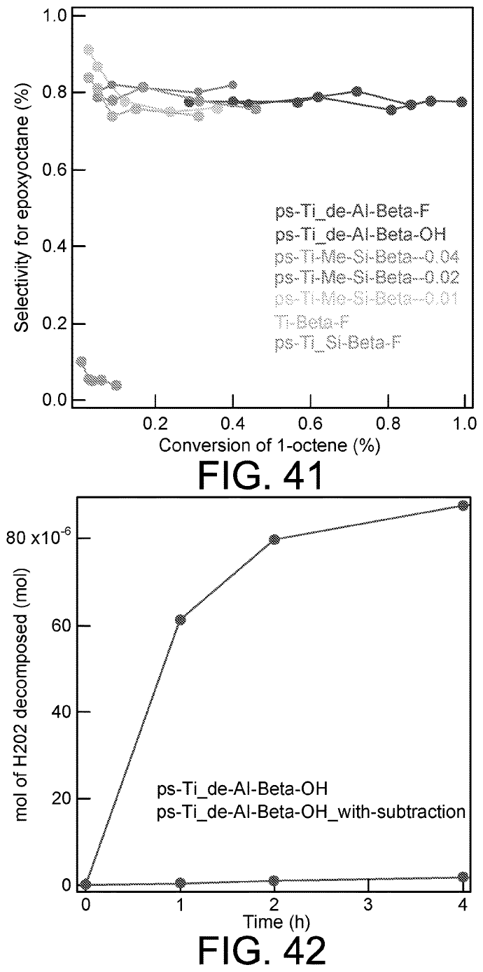

The reaction is first tested in a batch reactor with ps-Ti-de-Al-Beta-OH. Consistent formation of 1,2-epoxyoctane is observed following pseudo first order kinetics with 10× equivalents of hydrogen peroxide (k=0.95 hr⁻¹). The selectivity of the reaction is steadily around 80% as measured through the observed yield of the epoxide over the conversion of the alkene. However, no other side products are detected, including 1-octene-3-ol and 1-octene-3-one, and less than 1 mol % formation of the water ring opening product, 1,2 octane diol, is observed. In comparison, ps-Ti-de-Al-Beta-F is tested and results in almost double of the activity (k=1.8 hr⁻¹). This is unexpected as this catalyst is significantly more hydrophobic than its hydroxide counterpart. This is inconsistent with the idea that the activity for epoxidation solely relies on the hydrophilicity of the zeolite framework. It is likely that differences in the actual Ti speciation may exist between the two de-aluminated materials. See FIGS. 40-41.

Ti-Beta-F is tested and results in a dramatically decreased activity (k=0.13 hr⁻¹) while exhibiting identical selectivity. This is consistent with previous literature, showing that the hydrophobic Ti-Beta-F has an order of magnitude decreased activity compared to post synthetic materials. Ps-Ti-Me-Si-Beta is tested and gives similar activity (k=0.19 hr⁻¹) to that of Ti-Beta-F, while again demonstrating high selectivity. This result once again demonstrates similar catalytic performance of ps-Ti-Me-Si-Beta to hydrothermally synthesized Ti-Beta-F. While results from the MPV reaction suggest that these materials have different percentages of active Ti sites, this data suggests that the Ti sites in Me-Si-Beta are more active, possibly caused by a partially hydrophilic environment caused by inherent defects from the methyl silane. These results are contrasted with the catalytic performance of ps-Ti—Si-Beta that leads to very low activity (k=0.032 hr⁻¹), and dramatically decreased selectivity for the epoxide.

To gather more information about the Ti speciation in the catalysts, hydrogen peroxide degradation rates are measured during reaction. It has been reported that peroxide decomposes more rapidly on extra-framework TiO₂ sites. During the epoxidation reaction, the overall concentration of peroxide is measured to determine the total amount consumed. After subtracting the yield of the epoxide, it is observed that the decomposition rate of peroxide is negligible. The rate of decomposition is over two orders of magnitude slower than the rate of epoxidation for all catalysts, and the rate does not appear to vary significantly (less than ×2 between catalysts, below accurate levels of detection). See FIG. 42.

Overall, the results of the epoxidation reaction are consistent with previous literature, showing that the de-Al-Beta material display significantly higher activity. Further, ps-Ti-Me-Si-Beta displays catalytic performance similar to Ti-Beta-F, revealing that creating defects with alkyl silane proves to be a potential method to create hydrophobic defect materials similar to their hydrothermal counterparts.

### CONCLUSIONS

In this work, a procedure using dilute methyl silane (Me-Si) is used to crystallize zeolite beta containing controlled defects. FTIR spectroscopy and water adsorption experiments are used to reveal that Me-Si-Beta contains isolated silanols within the framework that do not have strong enough interactions to support the stabilization of large water clusters. It is believed that small amounts of Me-Si (1%) lead to functionalization of the outer surface, and therefore increasing amounts of Me-Si (up to 4%) are needed to create defects that can support the post-synthetic incorporation of isolated Ti atoms.

Upon incorporation of Ti atoms, ps-Ti-Me-Si-Beta is compared to its de-Al-Beta counterparts and hydrothermally synthesized Ti-Beta-F. In both cases of 1-octene epoxidation and the MPV reduction of furfural, the ps-Ti-Me-Si-Beta sample behaved more catalytically similar to the hydrothermal material rather than its de-Al-Beta counterpart. This reveals that this procedure could be used to create post-synthetic catalysts that are more hydrophobic than typical de-aluminated zeolites. Overall, this work provides a novel procedure to create controlled defects within zeolites and promotes the further understanding of how synthesis-structure relationships can be used to create valuable catalyst.

### REFERENCES

(1) Satterfield; Tech., C. N. Heterogeneous Catalysis in Industrial Practice. 2nd Edition; New York, NY (United States); McGraw Hill Book Co., 1991.
(2) Luque, R., et al., Heterogeneous Catalysis. 2022.
(3) Lewis, J. D., et al., Acid-Base Pairs in Lewis Acidic Zeolites Promote Direct Aldol Reactions by Soft Enolization. Angew. Chemie Int. Ed. 2015, 54(34), 9835-9838.
(4) Koehle, M., et al., Lewis Acidic Zeolite Beta Catalyst for the Meerwein-Ponndorf-Verley Reduction of Furfural. Catal. Sci. Technol. 2016, 6(9), 3018-3026.
(5) Gordon, C. P., et al., Efficient Epoxidation over Dinuclear Sites in Titanium Silicalite-1. Nature 2020, 586 (7831), 708-713.
(6) Vega-Vila, J. C., et al., Controlled Insertion of Tin Atoms into Zeolite Framework Vacancies and Consequences for Glucose Isomerization Catalysis. 2016.
(7) Bregante, D. T., et al., Cooperative Effects between Hydrophilic Pores and Solvents: Catalytic Consequences of Hydrogen Bonding on Alkene Epoxidation in Zeolites. J. Am. Chem. Soc. 2019, 141(18), 7302-7319.
(8) Harris, J. W., et al., Molecular Structure and Confining Environment of Sn Sites in Single-Site Chabazite Zeolites. 2017.
(9) Verified Syntheses of Zeolitic Materials; Elsevier, 2001.
(10) Wolf, P., et al., Post-Synthetic Preparation of Sn—, Ti—and Zr-Beta: A Facile Route to Water Tolerant, Highly Active Lewis Acidic Zeolites. Dalt. Trans. 2014, 43 (11), 4514.
(11) Bregante, D. T., et al., The Shape of Water in Zeolites and Its Impact on Epoxidation Catalysis. Nat. Catal. 2021, 4 (9), 797-808.
(12) Bregante, D. T., et al., Cooperative Effects between Hydrophilic Pores and Solvents: Catalytic Consequences of Hydrogen Bonding on Alkene Epoxidation in Zeolites. J. Am. Chem. Soc. 2019, 141(18), 7302-7319.
(13) Spanos, A. P., et al., Enhancing Hydrophobicity and Catalytic Activity of Nano-Sn-Beta for Alcohol Ring Opening of Epoxides through Post-Synthetic Treatment with Fluoride. J. Catal. 2021.
(14) Dai, W., et al., Spectroscopic Signature of Lewis Acidic Framework and Extraframework Sn Sites in Beta Zeolites. ACS Catal. 2020, 10 (23), 14135-14146.
(15) Yamamoto, K., et al., Organic-Inorganic Hybrid Zeolites with Framework Organic Groups. 2005.
(16) Parulkar, A., et al., Synthesis and Catalytic Testing of Lewis Acidic Nano Zeolite Beta for Epoxide Ring Opening with Alcohols. Appl. Catal. A Gen. 2019, 577 (December 2018), 28-34.
(17) Lewis, J. D., et al., Distinguishing Active Site Identity in Sn-Beta Zeolites Using 31 P MAS NMR of Adsorbed Trimethylphosphine Oxide. ACS Catal. 2018, 8 (4), 3076-3086.
(18) Bregante, D. T. et al., Impact of Specific Interactions among Reactive Surface Intermediates and Confined Water on Epoxidation Catalysis and Adsorption in Lewis Acid Zeolites. ACS Catal. 2019, 9 (12), 10951-10962.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A method for preparing a zeolitic material comprising a microporous crystalline framework isomorphously substituted with one or more paired Lewis acid sites,
wherein each of the one or more paired Lewis acid sites comprises a first Lewis acid metal center and a second Lewis acid metal center, and
wherein the first Lewis acid metal center and the second Lewis acid metal center are separated by three or fewer atoms within the crystalline framework; the method comprising:
(i) combining, in aqueous solution, a silicon source, a Lewis acid metal precursor, and optionally a structure-directing agent to form a precursor gel;
(ii) reacting the precursor gel under conditions effective to form a protected zeolitic material;
(iii) treating the protected zeolitic material to form the zeolitic material comprising the microporous crystalline framework isomorphously substituted with one or more paired Lewis acid-open defect sites, each comprising a first Lewis acid metal center and an open defect site; and
(iv) post-synthetically incorporating a metal at the open defect sites to form one or more paired Lewis acid sites comprises a first Lewis acid metal center and a second Lewis acid metal center.

2. The method of claim 1, wherein step (i) comprises combining, in aqueous solution, the silicon source, the Lewis acid metal precursor, and the structure-directing agent to form a precursor gel.

3. The method of claim 1, wherein step (ii) comprises incubating the precursor gel to hydrolyze the silicon source.

4. The method of claim 1, wherein step (ii) comprises heating the precursor gel in the presence of zeolite seed crystals, a fluoride source, or a combination thereof to form the protected zeolitic material.

5. The method of claim 1, wherein step (iii) comprises calcining the protected zeolitic material to form the zeolitic material comprising the microporous crystalline framework isomorphously substituted with one or more paired Lewis acid-open defect sites.

6. The method of claim 5, wherein calcining is performed immediately after step (ii).

7. The method of claim 5, wherein calcining is performed from 5 minutes after step (ii) to 10 days after step (ii).

8. The method of claim 5, wherein calcining is performed at least 7 days after step (ii).

9. The method of claim 1, wherein step (iii) comprises heating the protected zeolitic material in air at a temperature of from 400° C. to 750° C.

10. The method of claim 1, wherein step (iii) comprises extracting the protected zeolitic material to form the zeolitic material comprising the microporous crystalline framework isomorphously substituted with one or more paired Lewis acid-open defect sites.

11. The method of claim 1, wherein the Lewis acid metal precursor is defined by Formula II: 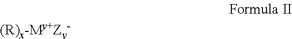
wherein
R is alkyl, cycloalkyl, aryl, or any combination thereof,
M is a transition metal, post transition metal, or any combination thereof,
Z is a halogen, acetate, sulfate, nitrate phosphate, carbonate, or bicarbonate,
x is an integer from 1-3, and
y is an integer from 1-3, wherein the total charge of the compound of Formula II is a neutral charge.

12. The method of claim 11, wherein M comprises a post-transition metal.

13. The method of claim 11, wherein M is chosen from Sn, Hf, Zn, Zr, Ti, V, Ta, Ga, Ge, Nb, and Cr.

14. (canceled)

15. The method of claim 11, wherein R comprises C₁-C₁₀ alkyl, C₃-C₁₀ cycloalkyl, C₃-C₁₀ aryl, or any combination thereof.

16. (canceled)

17. (canceled)

18. The method of claim 11, wherein Z comprises a halogen.

19. (canceled)

20. The method of claim 11, wherein x is 1.

21. The method of claim 11, wherein y is 3.

22. The method of claim 11, wherein the Lewis acid metal precursor is methyl-Sn—Cl₃, n-butyl-Sn—Cl₃, phenyl-Sn—Cl₃, or a combination thereof.

23. (canceled)

24. (canceled)

25. A zeolitic material prepared by the method of claim 1.

26. The zeolitic material of claim 25, wherein the zeolitic material has improved catalytic activity at least 10 days after calcination

27. (canceled)
